(19) United States
(12) Patent Application Publication
(10) Pub. No.: US 2024/0014894 A1
(43) Pub. Date: Jan. 11, 2024

(54) SATELLITE WATCHING SYSTEM, SATELLITE INFORMATION TRANSMISSION SYSTEM, GROUND EQUIPMENT, COMMUNICATION SATELLITE, MONITORING SYSTEM, CONSTITUENT SATELLITE, ARTIFICIAL SATELLITE, COMMUNICATION SATELLITE CONSTELLATION, SATELLITE CONSTELLATION, AND SATELLITE

(71) Applicant: Mitsubishi Electric Corporation, Tokyo (JP)

(72) Inventor: Hisayuki MUKAE, Tokyo (JP)

(73) Assignee: Mitsubishi Electric Corporation, Tokyo (JP)

(21) Appl. No.: 18/024,510

(22) PCT Filed: Sep. 17, 2021
(86) PCT No.: PCT/JP2021/034410

§ 371 Date: Mar. 3, 2023

(30) Foreign Application Priority Data
Sep. 28, 2020 (JP) 2020-162718

(51) Int. Cl. H04B 7/185; H04B 7/195

(52) U.S. Cl. CPC H04B 7/18519; H04B 7/195

(57) ABSTRACT

A communication satellite group (44) that is composed of infrastructure satellites flying in an earth orbit (LEO) flies in an orbit with an orbital altitude and an orbital inclination angle which are features of a sun-synchronous orbit, the communication satellite group (44) orbiting an integer number of times per day in a substantially uniform arrangement. The communication satellite group (44) includes a first satellite (61) communicating with ground equipment (701), a second satellite (62) communicating with a watching satellite (521), and a third satellite (63) performing only communication with communication satellites flying in front and behind. A watching satellite (521b) and the ground equipment (701) exchange information via the communication satellite group (44).

### TECHNICAL FIELD

The present disclosure relates to a satellite watching system, a satellite information transmission system, ground equipment, a communication satellite, a monitoring system, a constituent satellite, an artificial satellite, a communication satellite constellation, a satellite constellation, and a satellite.

### BACKGROUND ART

Satellite-based social infrastructure, such as information exchange with distant or remote areas via communication satellites, weather forecasting using images from the Himawari weather satellite, and the use of geospatial information from quasi-zenith positioning satellites, has become established in social life. These practical satellite groups have become critical infrastructure that is indispensable to social life. On the other hand, due to factors such as debris collisions caused by an increase in the number of objects in the space environment, dangerous events with the risk of failure or loss of critical infrastructure have been increasing.

This requires a mechanism to watch critical infrastructure and take a hazard avoidance action if necessary.

Patent Literature 1 discloses a method for observing space debris in a space where sunlight is backlit.

### CITATION LIST

### Patent Literature

Patent Literature 1: JP 2011-218834 A

### SUMMARY OF INVENTION

### Technical Problem

A satellite group flying in an earth orbit (LEO) has a problem in that if an infrastructure satellite is flying over the other side of the Earth in the event of a situation requiring urgent response, communication environment with a watching center cannot be secured. Here, the earth orbit is, for example, an orbit with an orbital altitude from 500 km to 2000 km inclusive. LEO is an abbreviation for Low Earth Orbit.

Patent Literature 1 does not disclose a method for watching critical infrastructure in the earth orbit.

An object of the present disclosure is to secure a communication environment between a watching satellite and a watching center in a satellite group flying in the earth orbit.

### Solution to Problem

A satellite watching system according to the present disclosure includes:
a critical infrastructure to be a social infrastructure in outer space and to be composed of an infrastructure satellite group, the infrastructure satellite group being composed of infrastructure satellites flying in an earth orbit (LEO) with an orbital altitude between 500 km and 2000 km inclusive;
a watching satellite group to be composed of a watching satellite, the watching satellite flying in an orbit with an orbital altitude of 2000 km or lower to monitor the infrastructure satellite group and provide an on-orbit service;
ground equipment to be located on a ground and to exchange information with each of the infrastructure satellites of the infrastructure satellite group; and
a watching center to be located on the ground and to exchange information with the watching satellite, wherein
the infrastructure satellite group includes a communication satellite group to be composed of a communication satellite,
the communication satellite group flies in an orbit with an orbital altitude and an orbital inclination angle which are features of a sun-synchronous orbit, the communication satellite group orbiting an integer number of times per day in a uniform arrangement,
the communication satellite communicates with communication satellites flying in front and behind,
the communication satellite group includes
   a first satellite to communicate with the ground equipment,
   a second satellite to communicate with the watching satellite, and
   a third satellite to perform only communication with communication satellites flying in front and behind, and
the watching satellite and the watching center exchange information via the communication satellite group.

### Advantageous Effects of Invention

In the satellite watching system according to the present disclosure, a communication satellite group, which is included in an infrastructure satellite group, flies in an orbit with an orbital altitude and an orbital inclination angle which are features of a sun-synchronous orbit, the communication satellite group orbiting an integer number of times per day in a substantially uniform arrangement. Then, the watching satellite and the watching center exchange information via the communication satellite group. Thus, the satellite watching system according to the present disclosure has an advantageous effect that the communication environment between the watching satellite and the watching center can be secured in a satellite group flying in the earth orbit.

### BRIEF DESCRIPTION OF DRAWINGS

FIG. 1 is a drawing illustrating an entire configuration example of a satellite watching system according to Embodiment 1.

FIG. 2 is a drawing illustrating a configuration example of a watching center according to Embodiment 1.

FIG. 3 is a drawing illustrating a configuration example of a satellite, which is an example of a space object, according to Embodiment 1.

FIG. 4 is a drawing illustrating a configuration example of a communication satellite according to Embodiment 1.

FIG. 5 is a drawing illustrating a configuration example of an observation satellite according to Embodiment 1.

FIG. 6 is a drawing illustrating another example of a configuration of the observation satellite according to Embodiment 1.

FIG. 7 is a drawing illustrating a configuration example of the satellite watching system according to Embodiment 1.

FIG. 8 is a drawing illustrating configuration example 3 of a communication satellite group according to Embodiment 1.

FIG. 9 is a drawing illustrating configuration example 4 of the communication satellite group according to Embodiment 1.

FIG. 10 is a drawing illustrating a communication method of the communication satellite group according to Embodiment 1.

FIG. 11 is a drawing illustrating a configuration example of a satellite information transmission system according to Embodiment 2.

FIG. 12 is a drawing illustrating an entire configuration example of the satellite information transmission system according to Embodiment 2.

FIG. 13 is a drawing illustrating a communication method of the communication satellite group according to Embodiment 2.

FIG. 14 is a drawing illustrating a drawing for explaining ground equipment according to Embodiment 3.

FIG. 15 is a drawing illustrating a drawing for explaining example 1 of a communication satellite according to Embodiment 3.

FIG. 16 is a drawing illustrating a drawing illustrating an example of a satellite information transmission system according to Embodiment 3.

FIG. 17 is a drawing illustrating a drawing for explaining example 2 of the communication satellite according to Embodiment 3.

FIG. 18 is a drawing illustrating a configuration example of a monitoring system according to Embodiment 4.

FIG. 19 is a drawing illustrating a configuration example of example 1 of a first satellite constellation according to Embodiment 4.

FIG. 20 is a drawing illustrating a configuration example of example 2 of the first satellite constellation according to Embodiment 4.

FIG. 21 is a drawing illustrating a configuration example of example 4 of a second satellite constellation according to Embodiment 4.

FIG. 22 is a drawing illustrating communication method example 1 of a satellite information transmission system according to Embodiment 5.

FIG. 23 is a drawing illustrating an entire configuration example of the satellite information transmission system according to Embodiment 5.

FIG. 24 is a drawing illustrating communication method example 6 of the satellite information transmission system according to Embodiment 5.

FIG. 25 is a drawing illustrating a configuration example of an artificial satellite according to Embodiment 6.

FIG. 26 is a drawing illustrating a configuration example of a communication satellite constellation according to Embodiment 6.

FIG. 27 is a drawing illustrating a configuration example of a satellite constellation according to Embodiment 6.

FIG. 28 is a drawing illustrating another example of the configuration of the satellite constellation according to Embodiment 6.

FIG. 29 is a drawing illustrating a configuration example of example 1 of a satellite information transmission system according to Embodiment 6.

FIG. 30 is a drawing illustrating a configuration example of example 2 of the satellite information transmission system according to Embodiment 6.

FIG. 31 is a drawing illustrating a configuration example of example 3 of the satellite information transmission system according to Embodiment 6.

FIG. 32 is a drawing illustrating a configuration example of example 4 of the satellite information transmission system according to Embodiment 6.

FIG. 33 is a drawing illustrating a configuration example of example 5 of the satellite information transmission system according to Embodiment 6.

### DESCRIPTION OF EMBODIMENTS

Embodiments of the present disclosure will be described below with reference to the accompanying drawings. Here, the same reference characters are given to the same or corresponding portions among the drawings. In the description of the embodiments, description will be omitted or simplified as appropriate for the same or corresponding portions. Further, in the following drawings, the relation between the sizes of components may differ from the actual relation. In addition, directions or positions such as “top”, “bottom”, “left”, “right”, “forward”, “rearward”, “front”, and “back” may be indicated in the description of the embodiments. These notations are for convenience of explanation and do not limit the arrangement and orientation of devices, appliances, parts, or the like.

### Embodiment 1

***Description of Entire Configuration of Satellite Watching System 500***

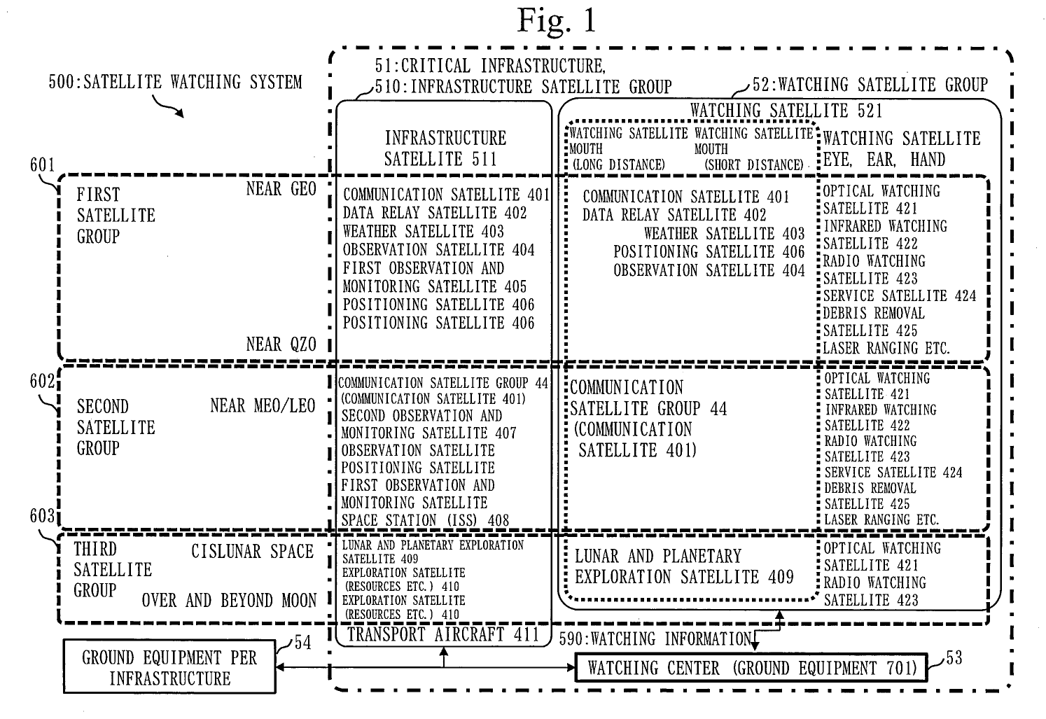

FIG. 1 is a drawing illustrating an entire configuration example of a satellite watching system 500 according to the present embodiment.

The satellite watching system 500 includes a watching satellite group 52 and a watching center 53 that monitor a critical infrastructure 51. The satellite watching system 500 may be configured to include the critical infrastructure 51 in addition to the watching satellite group 52 and the watching center 53. A watching satellite 521 is also called a monitoring satellite or a monitoring device.

The critical infrastructure 51 is an infrastructure in outer space.

Specific examples of the critical infrastructure 51 are formed by a satellite group constituting the following social infrastructures.
Information exchange with distant or remote areas via communication satellites
Weather forecasting using images from the Himawari weather satellite
Use of geospatial information from quasi-zenith positioning satellites

Satellites constituting the critical infrastructure 51 are referred to as infrastructure satellites 511.

The watching satellite group 52 is composed of the watching satellite 521 that monitors the infrastructure satellites 511 constituting the critical infrastructure 51.

The watching center 53 is located on the ground and exchanges information with the watching satellites 521 of the watching satellite group 52.

The watching satellite 521 of the watching satellite group 52 and the watching center 53 exchange information via a communication device provided to the infrastructure satellite 511.

The satellite group constituting the critical infrastructure 51 includes a satellite provided with the communication device communicating with the watching center 53, as the infrastructure satellite 511.

The infrastructure satellite 511 includes all or part of a communication satellite 401, a data relay satellite 402, a weather satellite 403, an observation satellite 404, a first observation and monitoring satellite 405, a positioning satellite 406, a second observation and monitoring satellite 407, a space station 408, a lunar and planetary exploration satellite 409, an exploration satellite 410, and a transport aircraft 411. The exploration satellite 410 is an exploration satellite that explores planets other than the Moon or resources.

The first observation and monitoring satellite 405 is a satellite that is arranged in a high orbit, such as a geostationary earth orbit and Molniya orbit, and performs extensive observation, monitoring, or the like of the ground, for example.

The second observation and monitoring satellite 407 is an observation or monitoring satellite for collecting various kinds of important image information of major disasters and the like, for example.

Further, ground equipment per infrastructure 54 that corresponds to the critical infrastructure 51 is located on the ground. The ground equipment per infrastructure 54 is an example of ground equipment that is located on the ground and exchanges information with each infrastructure satellite of an infrastructure satellite group 510.

Due to factors such as debris collisions caused by an increase in the number of objects in the space environment, dangerous events with the risk of failure or loss of the critical infrastructure 51 have been increasing.

This requires a mechanism to watch the critical infrastructure 51 and take a hazard avoidance action if necessary.

The watching satellite group 52 includes the infrastructure satellite 511 that is provided with the communication device communicating with the watching center 53, as the watching satellite 521.

The watching satellite 521 includes all or part of an optical watching satellite 421, a radio watching satellite 423, an infrared watching satellite 422, a service satellite 424, and a debris removal satellite 425. The optical watching satellite 421 monitors the infrastructure satellite 511 by using an optical system. The radio watching satellite 423 monitors the infrastructure satellite 511 by using a radio wave. The infrared watching satellite 422 monitors the infrastructure satellite 511 by using infrared detection. The service satellite 424 performs on-orbit services to the infrastructure satellite 511. The debris removal satellite 425 removes debris.

On-orbit services include all or part of capture, inspection, repair, refueling, transfer, deorbit (ADR: Active Debris Removal), and laser irradiation.

The watching service by the watching satellite group 52 can be easily understood by analogy with the roles of an eye, an ear, a hand, and a mouth. In order to realize a purpose of visually watching the critical infrastructure 51 with an eye using a satellite, a method for visually monitoring a suspicious object such as debris through optical telescopes or radar images is effective. In addition, a method for monitoring an abnormal temperature environment by infrared detection is also effective.

Also, the watching service of auditory watching with an ear has the purpose of monitoring a radio wave in outer space where a sound wave does not propagate. In order to realize a purpose of aurally watching the critical infrastructure 51 with an ear using a satellite, a method for receiving radio waves flying around and monitoring a condition of a radio wave that may cause a malfunction is effective.

In addition, as an extension service of the watching, an on-orbit service can be cited as an analogy with the role of operating with a hand. The on-orbit service includes services of capture, inspection, and repair of a failed satellite. In addition, the on-orbit service includes refueling to a satellite running out of fuel, a transfer service for moving a service position, and active deorbit (ADR) of a satellite which is unable to deorbit by itself after completing its lifetime. Further, a service for monitoring a distance from a suspicious object such as debris through irradiation with laser is also included.

Thus, the watching satellite 521 is expected to realize the roles of the eye, ear, or hand.

However, the role of the mouth, that is, communication means for transmitting watching information 590 is restricted and requires ingenuity.

In the present embodiment, the infrastructure satellite 511 is used as the watching satellite 521 taking the role of the mouth, that is, the watching satellite 521 that transmits the watching information 590.

The watching satellite 521 includes the infrastructure satellite 511 as the watching satellite 521 taking the role of the mouth. Further, the watching satellite 521 taking the role of the mouth is included in the infrastructure satellite 511. That is, in the satellite watching system 500, there is a satellite that serves as the watching satellite 521 and the infrastructure satellite 511. In this example, it has been described that this kind of satellite is mainly the infrastructure satellite 511 taking the role of the mouth, but the satellite may be a satellite taking a role of the eye, ear, or hand.

As illustrated in FIG. 1, the watching satellite 521 performing long-range communication includes the communication satellite 401 and the data relay satellite 402 of a first satellite group 601. The communication satellite 401 of a second satellite group 602 is also included. The lunar and planetary exploration satellite 409 of a third satellite group 603 is further included.

The watching satellite 521 performing short-range communication includes the weather satellite 403, the positioning satellite 406, and the observation satellite 404 of the first satellite group 601.

As illustrated in FIG. 1, the satellite watching system 500 includes the first satellite group 601, the second satellite group 602, the third satellite group 603, and the watching center 53.

The first satellite group 601 is composed of a satellite group flying near a Geostationary Earth Orbit (GEO) or a Quasi-Zenith Orbit (QZO).

The second satellite group 602 is composed of a satellite group flying near a Medium Earth Orbit (MEO) or a Low Earth Orbit (LEO).

The third satellite group 603 is composed of a satellite group flying in cislunar space, which is space between the Moon and the Earth, or flying over and beyond the Moon.

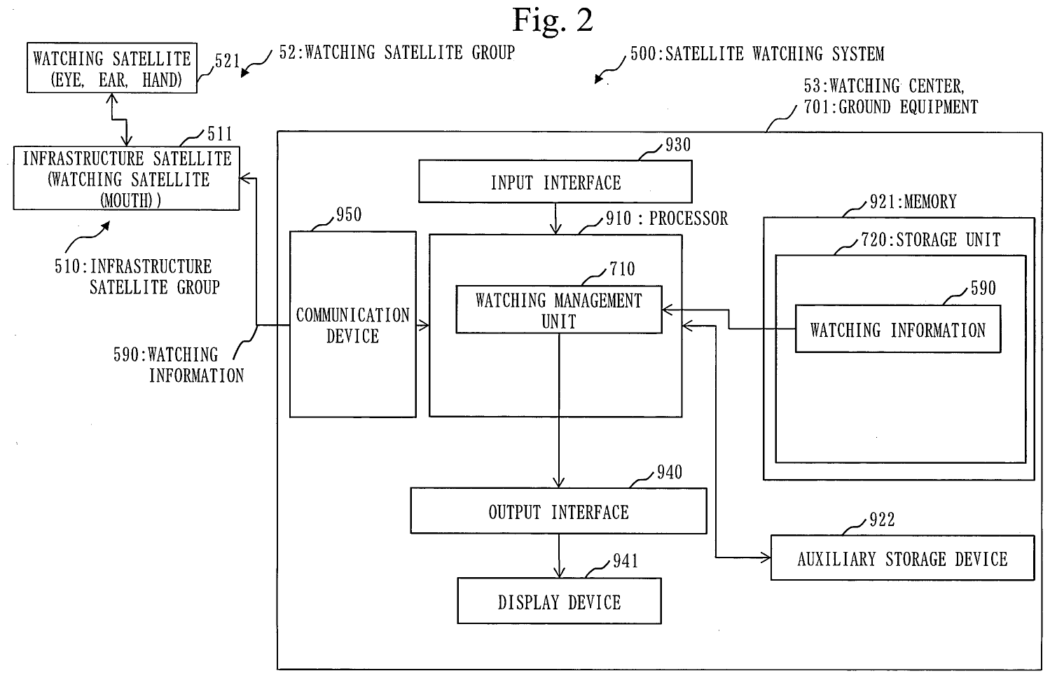

FIG. 2 is a configuration example of the watching center 53 according to the present embodiment.

The watching center 53 is also called ground equipment 701, which is located on the ground. Here, the description will be provided as the ground equipment 701.

The ground equipment 701 is provided with a computer.

The ground equipment 701 includes a processor 910 and other pieces of hardware such as a memory 921, an auxiliary storage device 922, an input interface 930, an output interface 940, and a communication device 950. The processor 910 is connected with other pieces of hardware via a signal line and controls the pieces of hardware.

The ground equipment 701 includes a watching management unit 710 and a storage unit 720 as examples of components. The storage unit 720 stores the watching information 590.

The function of the watching management unit 710 is realized by software. The storage unit 720 is included in the memory 921. Alternatively, the storage unit 720 may be included in the auxiliary storage device 922. Further, the storage unit 720 may be included in the memory 921 and the auxiliary storage device 922 in a separate manner.

The ground equipment 701 exchanges the watching information 590 with the watching satellite 521 via the infrastructure satellite 511. The watching management unit 710 realizes a function for handling the risk of failure or loss of the critical infrastructure 51 with the use of the watching information 590 exchanged with the watching satellite 521. For example, the watching management unit 710 realizes the functions such as hazard warning, hazard prevention, and hazard avoidance in the critical infrastructure 51.

The processor 910 is a device that executes a watching management program. The watching management program is a program for realizing functions of respective components of the ground equipment 701 and the satellite watching system 500.

The processor 910 is an IC (Integrated Circuit) performing arithmetic processing. Specific examples of the processor 910 include a CPU, a DSP (Digital Signal Processor), and a GPU (Graphics Processing Unit).

The memory 921 is a storage device for temporarily storing data. Specific examples of the memory 921 include a SRAM (Static Random Access Memory) and a DRAM (Dynamic Random Access Memory).

The auxiliary storage device 922 is a storage device for storing data. Specific examples of the auxiliary storage device 922 include an HDD. Further, the auxiliary storage device 922 may be a portable storage medium such as an SD (registered trademark) memory card, a CF, a NAND flash, a flexible disk, an optical disk, a compact disk, a Blu-ray (registered trademark) disk, and a DVD. Here, HDD is an abbreviation for Hard Disk Drive. SD (registered trademark) is an abbreviation for Secure Digital. CF is an abbreviation for Compact Flash (registered trademark). DVD is an abbreviation for Digital Versatile Disk.

The input interface 930 is a port that is connected with an input device such as a mouse, a keyboard, and a touch panel. The input interface 930 is specifically a USB (Universal Serial Bus) terminal. Here, the input interface 930 may be a port that is connected with a LAN (Local Area Network).

The output interface 940 is a port to which a cable of a display device 941 such as a display is connected. The output interface 940 is specifically a USB terminal or a HDMI (registered trademark) (High Definition Multimedia Interface) terminal. The display is specifically an LCD (Liquid Crystal Display).

The communication device 950 includes a receiver and a transmitter. The communication device 950 is specifically a communication chip or a NIC (Network Interface Card).

The watching management program is read in the processor 910 and executed by the processor 910. The memory 921 stores an OS (Operating System) as well as the watching management program. The processor 910 executes the watching management program while executing the OS. The watching management program and the OS may be stored in the auxiliary storage device. The watching management program and the OS stored in the auxiliary storage device are loaded on the memory 921 and executed by the processor 910. Here, part or the whole of the watching management program may be incorporated in the OS.

The ground equipment 701 may include a plurality of processors substituting for the processor 910. These plurality of processors share the execution of the watching management program. Each of the processors is a device that executes the watching management program as the processor 910.

Data, information, a signal value, and a variable value that are used, processed, or outputted based on the watching management program are stored in the memory 921, the auxiliary storage device 922, or a register or cache memory in the processor 910. The “unit” of the watching management unit 710 may be read as “processing”,

“procedure”, or “step”. The “processing” of the watching management processing may be read as “program”, “program product”, or “computer-readable storage medium on which a program is recorded”.

The watching management program makes a computer execute each processing, each procedure, or each step obtained by reading the “unit” of the watching management unit as “processing”, “procedure”, or “step”. Further, the watching management method is a method that is performed when the ground equipment 701 executes the watching management program.

The watching management program may be provided in a manner to be stored in a computer-readable recording medium or storage medium. Further, the watching management program may be provided as a program product.

In addition, the processor may be substituted with an electronic circuit. Each of a processor and an electronic circuit is also called processing circuitry. That is, the functions of respective devices of the satellite watching system 500 are realized by processing circuitry.

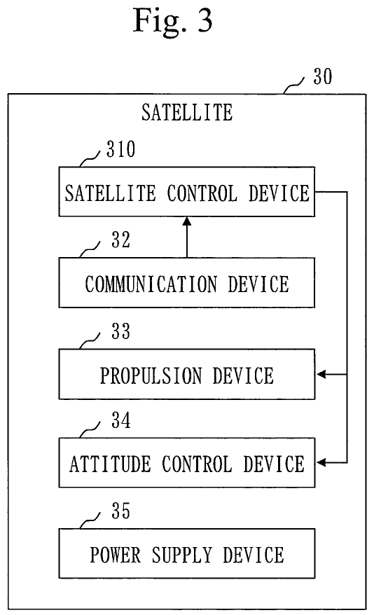

FIG. 3 is a configuration example of a satellite 30, which is an example of a space object, according to the present embodiment.

The satellite 30 includes a satellite control device 310, a communication device 32, a propulsion device 33, an attitude control device 34, and a power supply device 35. Components for realizing various functions are also included, but the satellite control device 310, the communication device 32, the propulsion device 33, the attitude control device 34, and the power supply device 35 will be described in FIG. 3. The satellite 30 is an example of a space object.

The satellite control device 310 is a computer that controls the propulsion device 33 and the attitude control device 34, and includes a processing circuit. Specifically, the satellite control device 310 controls the propulsion device 33 and the attitude control device 34 in accordance with various commands transmitted from a ground apparatus.

The satellite communication device 32 is a device that communicates with ground equipment or ground apparatus. Specifically, the communication device 32 transmits various kinds of data related to own satellite to the ground apparatus. Further, the communication device 32 receives various commands transmitted from the ground apparatus.

The propulsion device 33 is a device to provide propulsion to the satellite 30 and changes the speed of the satellite 30. Specifically, the propulsion device 33 is an apogee kick motor or chemical propulsion device, or an electric propulsion device. An Apogee Kick Motor (AKM) is an upper-stage propulsion device used to put an artificial satellite into orbit, and is also called an apogee motor (when a solid rocket motor is used) or an apogee engine (when a liquid engine is used).

The chemical propulsion device is a thruster that uses one- or two-component fuels. The electric propulsion device is an ion engine or Hall thruster. Apogee kick motor is the name of a device used for orbital transition and is a type of chemical propulsion device.

The attitude control device 34 is a device to control attitude elements such as the attitude of the satellite 30 and the angular velocity and line of sight of the satellite 30. The attitude control device 34 changes each attitude element in a desired direction. Alternatively, the attitude control device 34 keeps each attitude element in a desired direction. The attitude control device 34 includes an attitude sensor, an actuator, and a controller. The attitude sensor is a device such as a gyroscope, an earth sensor, a sun sensor, a star tracker, a thruster, and a magnetic sensor. The actuator is a device such as an attitude control thruster, a momentum wheel, a reaction wheel, and a control moment gyro. The controller controls the actuator in accordance with measurement data of the attitude sensor or various commands from the ground apparatus.

The power supply device 35 includes equipment such as a solar cell, a battery, and a power control device, and supplies power to each equipment mounted on the satellite 30.

The processing circuit included in the satellite control device 310 will be described.

The processing circuit may be dedicated hardware or a processor that executes a program stored in a memory.

In the processing circuit, a part of the function may be realized by dedicated hardware and the rest of the function may be realized by software or firmware. That is, the processing circuit can be realized by hardware, software, firmware, or a combination of these.

The dedicated hardware is specifically a single circuit, a composite circuit, a programmed processor, a parallel programmed processor, an ASIC, an FPGA, or a combination of these.

ASIC is an abbreviated name of Application Specific Integrated Circuit. FPGA is an abbreviated name of Field Programmable Gate Array.

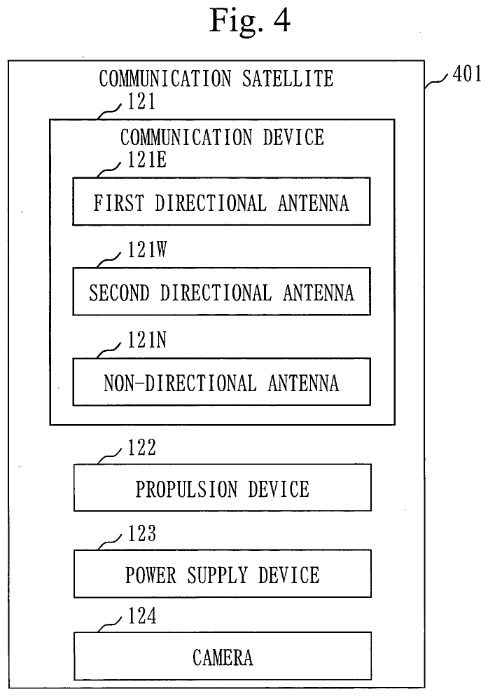

FIG. 4 is a drawing illustrating a configuration example of the communication satellite 401 according to the present embodiment.

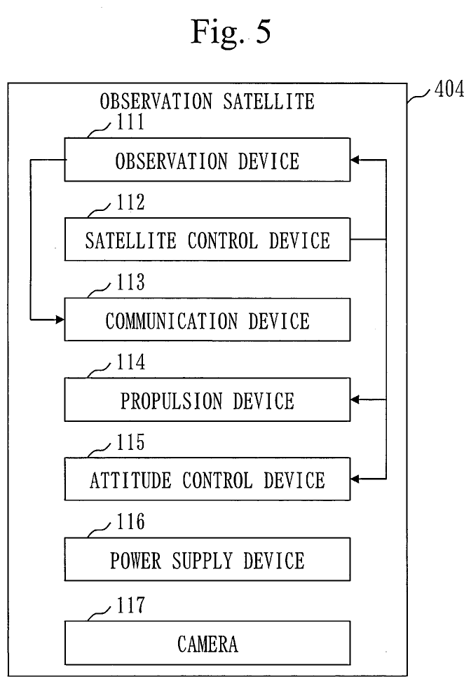

FIG. 5 is a drawing illustrating a configuration example of the observation satellite 404 according to the present embodiment.

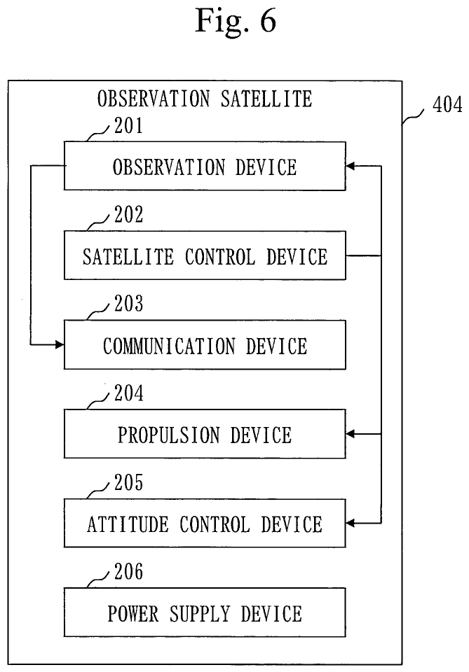

FIG. 6 is a drawing illustrating another example of a configuration of the observation satellite 404 according to the present embodiment.

In FIGS. 3 to 6, components having the same names have the same functions and the description thereof may be omitted.

The configuration of the communication satellite 401 will be described with reference to FIG. 4.

The communication satellite 401 includes a communication device 121, a propulsion device 122, a power supply device 123, and a camera 124.

For example, the camera 124 is a wide-angle camera that points in the same direction as that of a first directional antenna 121E or second directional antenna 121W.

The communication satellite 401 allows visual capture of an observation satellite and other space objects flying in a geostationary or near-geostationary earth orbit. This makes it possible to visually confirm that the environment around the communication satellite 401 is free from interference caused by communication and obstacles causing noise.

Other space objects are space objects that are different from space objects observed by the observation satellite.

The camera 124 is positioned so that the direction from the communication satellite 401 to the Earth is in a line-of-sight vector, allowing visual capture of the observation satellite 404 and other space objects flying in geostationary or near-geostationary earth orbits. In addition, positions of other space objects in orbit can be estimated. This makes it possible to visually confirm that the environment around the communication satellite 401 is free from interference and noise caused by communication.

The configuration of the observation satellite 404 will be described with reference to FIG. 5.

The observation satellite 404 includes an observation device 111, a satellite control device 112, a communication device 113, a propulsion device 114, an attitude control device 115, a power supply device 116, and a camera 117.

The observation device 111 is a device to observe space objects. The observation device 111 is also called monitoring equipment.

The camera 117 is, for example, a wide-angle camera that points at the communication satellite 401.

The camera 117 allows visual capture of the communication satellite 401 and other space objects flying in a geostationary or near-geostationary earth orbit. This makes it possible to visually confirm that the environment around the observation satellite 404 is free from interference and noise through communication.

The camera 117 is positioned so that the direction from the observation satellite 404 to the communication satellite 401 is in a line-of-sight vector, allowing visual capture of the communication satellite 401 and other space objects flying in geostationary or near-geostationary earth orbits. In addition, positions of other space objects in orbit can be estimated. This makes it possible to visually confirm that the environment around the observation satellite 404 is free from interference and noise caused by communication.

Another example of the configuration of the observation satellite 404 will be described with reference to FIG. 6.

The observation satellite 404 includes an observation device 201, a satellite control device 202, a communication device 203, a propulsion device 204, an attitude control device 205, and a power supply device 206.

The observation device 201 is a device to observe space objects.

The observation device 201 is a device to detect space objects with an optical system. The observation device 201 takes images of space objects, flying at an altitude different from the orbital altitude of the observation satellite, with an optical system. Specifically, the observation device 201 is a visible optical sensor.

The observation device 201 generates observation data. The observation data is data obtained through observation performed by the observation device 201. For example, the observation data corresponds to data representing images of space objects.

The satellite control device 202 is a computer that controls the observation satellite 404.

The satellite control device 202 controls the observation device 201, the propulsion device 204, and the attitude control device 205 in accordance with a default procedure or various commands transmitted from ground equipment.

The communication device 203 is a device that communicates with the ground equipment. It is also called a satellite communication device.

The communication device 203 transmits, for example, observation data to the ground equipment. Further, the communication device 203 receives, for example, various commands transmitted from the ground equipment.

***Description for Configuration and Operation of Satellite Watching System 500***

The present embodiment will mainly describe the configuration and the operation of the satellite watching system 500 in the second satellite group 602 illustrated in FIG. 1.

<Entire Configuration Example of Satellite Watching System 500>

The critical infrastructure 51 is a social infrastructure in outer space, in the present embodiment. The critical infrastructure 51 is composed of the infrastructure satellite group 510 that is composed of the infrastructure satellites 511 flying in an earth orbit (LEO: Low Earth Orbit) with an orbital altitude between 500 km and 2000 km inclusive.

The watching satellite group 52 is composed of the watching satellites 521 that fly in an orbit with an orbital altitude of 2000 km or lower to monitor the infrastructure satellite group 510 and provide on-orbit services.

The ground equipment per infrastructure 54 is an example of ground equipment that is located on the ground and exchanges information with each infrastructure satellite 511 of the infrastructure satellite group 510.

The watching center 53 is an example of ground equipment that is located on the ground and exchanges information with the watching satellite 521.

As illustrated in FIG. 1, the infrastructure satellite group 510 includes a communication satellite group 44 that is composed of the communication satellite 401.

The communication satellite group 44 flies in an orbit with an orbital altitude and an orbital inclination angle which are features of a sun-synchronous orbit, the communication satellite group 44 orbiting an integer number of times per day in a substantially uniform arrangement.

The communication satellite 401 communicates with communication satellites flying in front and behind.

The communication satellite group 44 includes a first satellite 61 communicating with ground equipment such as the ground equipment per infrastructure 54, a second satellite 62 communicating with a watching satellite 521b, and a third satellite 63 performing only communication with communication satellites flying in front and behind.

The watching satellite 521b and the watching center 53 exchange information via the communication satellite group 44.

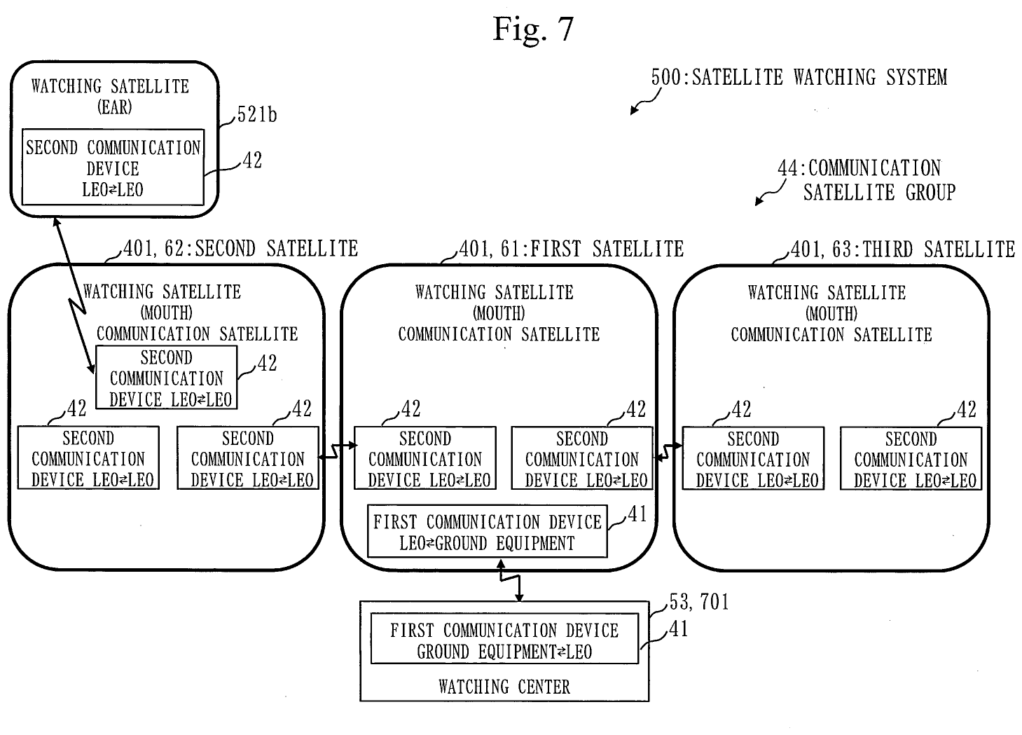

FIG. 7 is a drawing illustrating a configuration example of the satellite watching system 500 according to the present embodiment.

In FIG. 7, the watching satellite 521b playing the role of the ear is the infrastructure satellite 511 and communicates with the communication satellite 401 that is a watching satellite playing the role of the mouth. The communication satellite 401 communicating with the watching satellite 521b is an example of the second satellite 62. Here, the watching satellite 521b playing the role of the ear may be a watching satellite 521a playing the role of the eye or a watching satellite 521c playing the role of the hand.

The watching satellite 521b playing the role of the ear and the communication satellite 401 being an example of the second satellite 62 include second communication devices 42 for communication between infrastructure satellites.

The communication satellite 401 which is an example of the first satellite 61 includes a first communication device 41 that communicates with ground equipment. Further, the communication satellite 401 which is an example of the first satellite 61 also includes the second communication devices 42 for communication between infrastructure satellites.

The communication satellite 401, which is an example of the third satellite 63 performing only communication with communication satellites flying in front and behind, includes the second communication devices 42 for communication between infrastructure satellites.

There is a case that even if a situation requiring urgent response is generated when the infrastructure satellite 511 is flying over the other side of the Earth, a communication environment with the watching center 53 cannot be secured, in a satellite group flying in LEO.

However, the satellite watching system 500 according to the present embodiment has the environment in which a plurality of communication satellites communicate with each other, being able to perform exchange of watching information via a plurality of communication satellites from the other side of the Earth. Thus, there is an advantageous effect that watching information can be exchanged with the watching center anytime and anywhere.

This provides an advantageous effect of making it possible to immediately take a hazard avoidance action when a dangerous space object such as debris approaches the infrastructure satellite 511.

<Configuration Example 1 of Communication Satellite Group 44>

Each communication satellite 401 of the communication satellite group 44 flies in an orbit that is a sun-synchronous orbit with an orbital altitude of approximately 1666 km and makes 12 orbits per day. The communication satellite group 44 is composed of five or more communication satellites 401.

A sun-synchronous orbit is obtained by setting the orbital altitude of 12 orbits per day to approximately 1666 km and the orbital inclination angle to 77° (180°-103°).

A radius of an inscribed circle of a pentagon formed when five satellites fly in this orbit in equal phases is larger than the radius of the Earth, being able to secure the communication field of view between the satellites.

Assuming that the altitude at which the influence of the atmosphere can be ignored is 300 km, there is an advantageous effect that communication lines can be secured at an altitude of 585 km or higher above the Earth's surface if there are six or more satellites.

In addition, the satellites revisit the same latitude every day at the same time every two hours, providing an advantageous effect that information exchange can be performed at ground equipment at a frequency of every two hours at fixed time every day.

<Configuration Example 2 of Communication Satellite Group 44>

Each communication satellite 401 of the communication satellite group 44 flies in an orbit that is a sun-synchronous orbit with an orbital altitude of approximately 1248 km and makes 13 orbits per day. The communication satellite group 44 is composed of six or more communication satellites.

A sun-synchronous orbit is obtained by setting the orbital altitude of 13 orbits per day to approximately 1248 km and the orbital inclination angle to 79° (180°-101°).

A radius of an inscribed circle of a hexagon formed when six satellites fly in this orbit in equal phases is larger than the radius of the Earth, being able to secure the communication field of view between the satellites.

Assuming that the altitude at which the influence of the atmosphere can be ignored is 300 km, there is an advantageous effect that communication lines can be secured at an altitude of 491 km or higher above the Earth's surface if there are seven or more satellites.

The satellites revisit the same latitude every day at the same time every 111 minutes, providing an advantageous effect that information exchange can be performed at ground equipment at a frequency of every 111 minutes at fixed time every day.

<Configuration Example 3 of Communication Satellite Group 44>

Each communication satellite 401 of the communication satellite group 44 flies in an orbit that is a sun-synchronous orbit with an orbital altitude of approximately 881 km and makes 14 orbits per day. The communication satellite group 44 is composed of seven or more communication satellites.

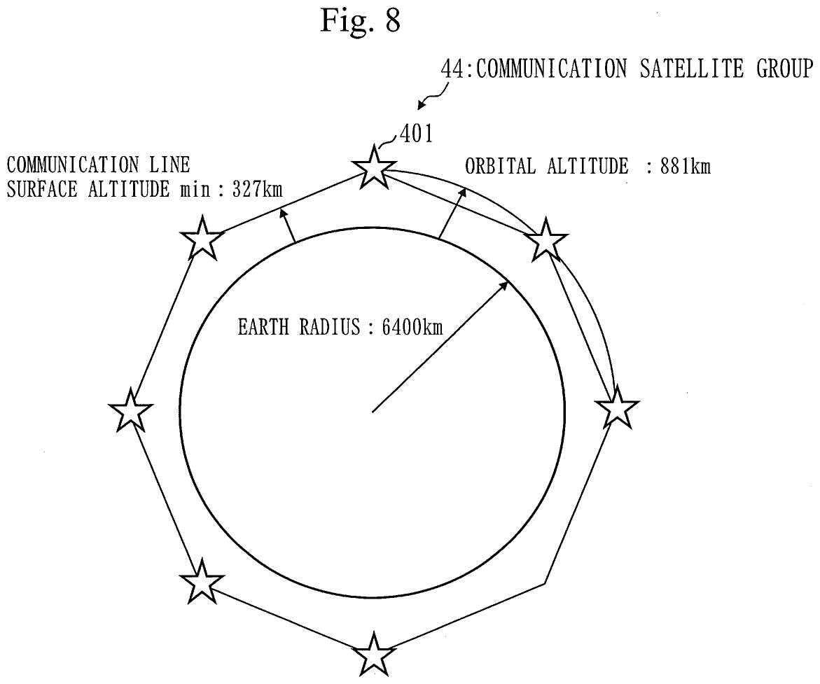

FIG. 8 is a drawing illustrating configuration example 3 of the communication satellite group 44 according to the present embodiment.

A sun-synchronous orbit is obtained by setting the orbital altitude of 14 orbits per day to approximately 881 km and the orbital inclination angle to 81° (180°-99°).

An orbit of 14 orbits per day can be achieved by setting orbital parameters with which sun-synchronization is obtained at an orbital altitude of 881 km. A radius of an inscribed circle of a hexagon formed when seven satellites fly in this orbit in equal phases is larger than the radius of the Earth, being able to secure the communication field of view between the satellites.

Assuming that the altitude at which the influence of the atmosphere can be ignored is 300 km, there is an advantageous effect that communication lines can be secured at an altitude of 327 km or higher above the Earth's surface if there are eight or more satellites.

The satellites revisit the same latitude every day at the same time every 103 minutes, providing an advantageous effect that information exchange can be performed at ground equipment at a frequency of every 103 minutes at fixed time every day. Here, the orbital inclination angle of 77° is the same as 103° depending on definition. Further, the orbital inclination angle of 79° is the same as 101° depending on definition. Furthermore, the orbital inclination angle of 81° is the same as 99° depending on definition.

<Configuration Example 4 of Communication Satellite Group 44>

The communication satellite group 44 is composed of a satellite group which is in a sun-synchronous orbit in two orbital planes at LST9:00 and LST15:00. LST is an abbreviation for Local Sun Time.

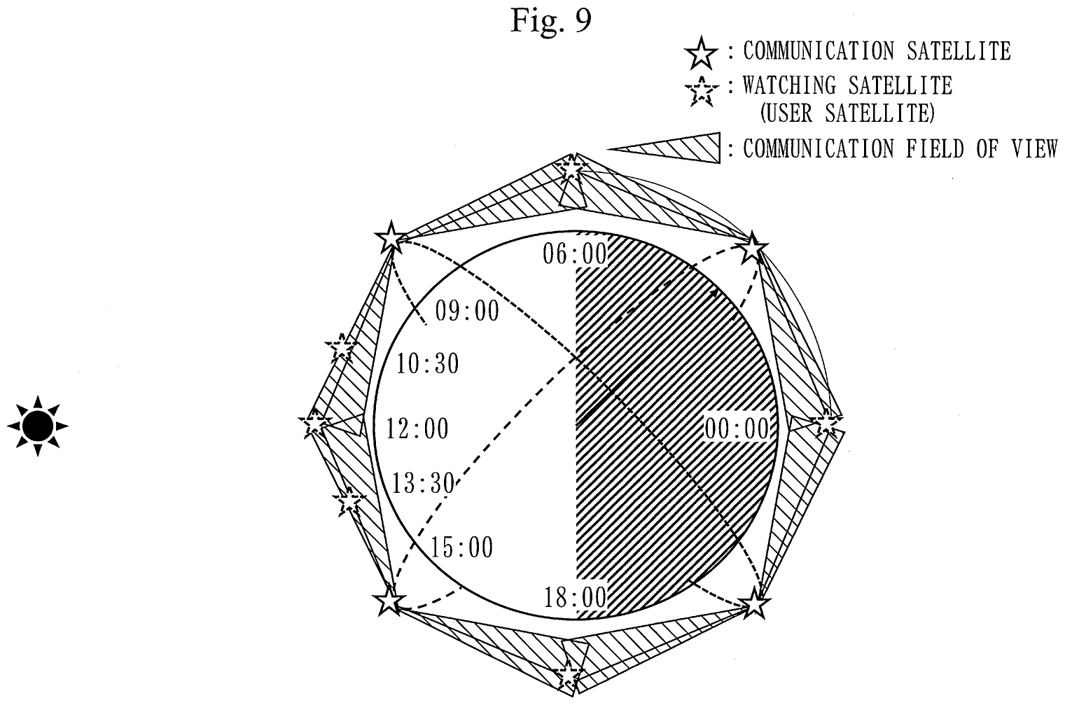

FIG. 9 is a drawing illustrating configuration example 4 of the communication satellite group 44 according to the present embodiment.

Earth observation satellites frequently use sun-synchronous orbits. Optical satellites frequently use around LST 10:30 and LST13:30 at which daylight conditions are good. In addition, radar satellites frequently use LST06:00 and LST18:00 which are favorable for solar power generation.

An inscribed circle of a regular octagon is 6727 km when an orbital altitude of a communication satellite is 881 km, accordingly being able to secure communication lines with watching satellites at any LST. Here, the watching satellite may be a user satellite that uses the communication satellite group 44 as a communication line.

Therefore, if communication satellites are arranged in two orbital planes at LST09:00 and LST15:00, an advantageous effect that communication can be performed with all satellite groups frequently used for earth observation is obtained.

<Communication Method of Communication Satellite Group 44>

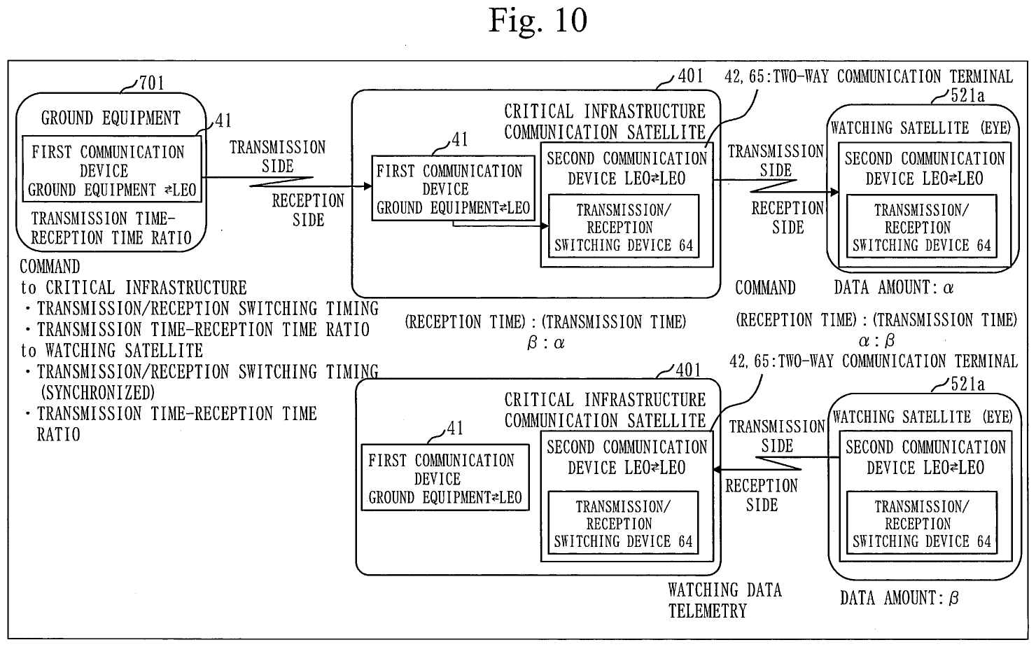

FIG. 10 is a drawing illustrating a communication method of the communication satellite group 44 according to the present embodiment.

The communication satellite 401 and the watching satellite 521 include a two-way communication terminal 65 including a transmission/reception switching device 64 that realizes reception and transmission by switching a receiving function and a transmitting function.

The ground equipment 701 which is the watching center 53 operates the transmission/reception switching device 64, based on a data amount α of a command, which is transmitted to the watching satellite 521, and a data amount 13 of watching data and telemetry, which are received from the watching satellite 521, so that a ratio between reception time and transmission time of the watching satellite 521 becomes α versus β. Specifically, the ground equipment 701 operates the transmission/reception switching device 64 based on the data amount α of a command, which is transmitted to the watching satellite 521, and the data amount β of watching report data, which is received from the watching satellite 521, so that a ratio between reception operating time, in which the receiving function of the two-way communication terminal 65 works, and transmission operating time, in which the transmitting function works, becomes α versus β.

The watching satellite 521 and the ground equipment 701 exchange information via the communication satellite 401.

The present embodiment has described the configuration example for information-exchanging of commands and watching report data between the watching satellite and the watching center. However, the watching satellites may be other user satellites that use the communication satellite group 44 as communication lines.

### Embodiment 2

The present embodiment will mainly describe the points to be added to Embodiment 1 or the points different from Embodiment 1. Here, the same components as those in Embodiment 1 will be provided with the same reference characters and the description thereof will be omitted as appropriate.

Embodiment 1 has mainly described the configuration in which the watching satellite 521 and the watching center 53 exchange information via the communication satellite group 44 which is included in the infrastructure satellite group 510.

The present embodiment will describe a satellite information transmission system 501 in which a user satellite 531 and ground equipment 702 exchange information via the communication satellite group 44 included in the infrastructure satellite group 510.

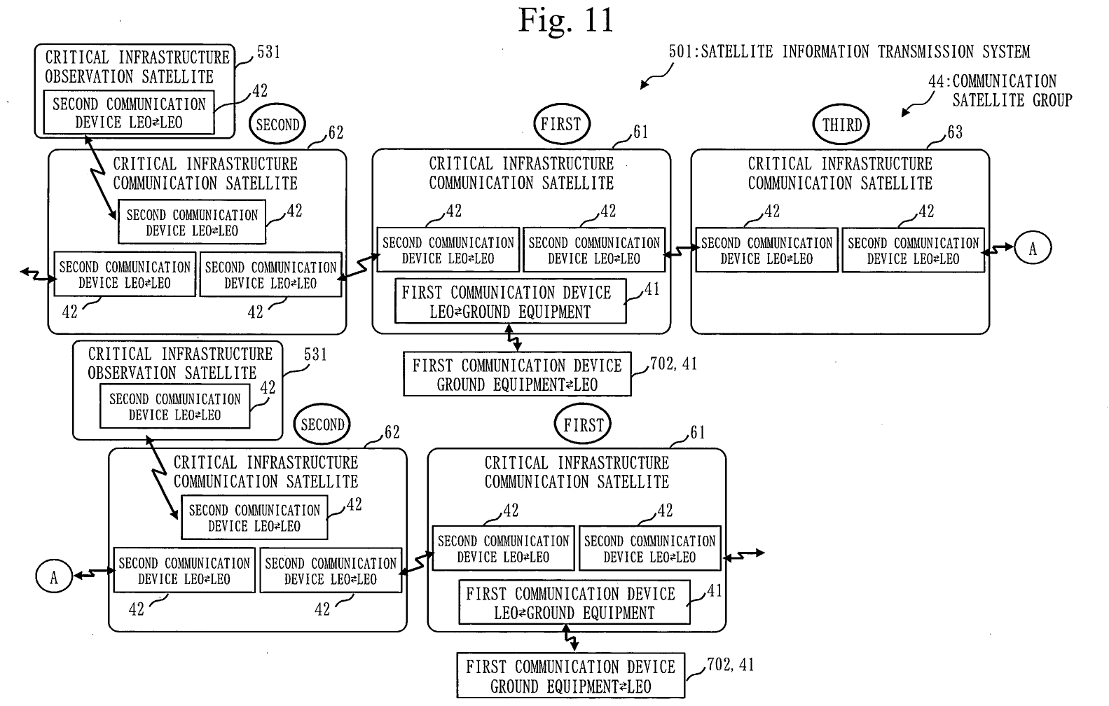

FIG. 11 is a drawing illustrating a configuration example of the satellite information transmission system 501 according to the present embodiment.

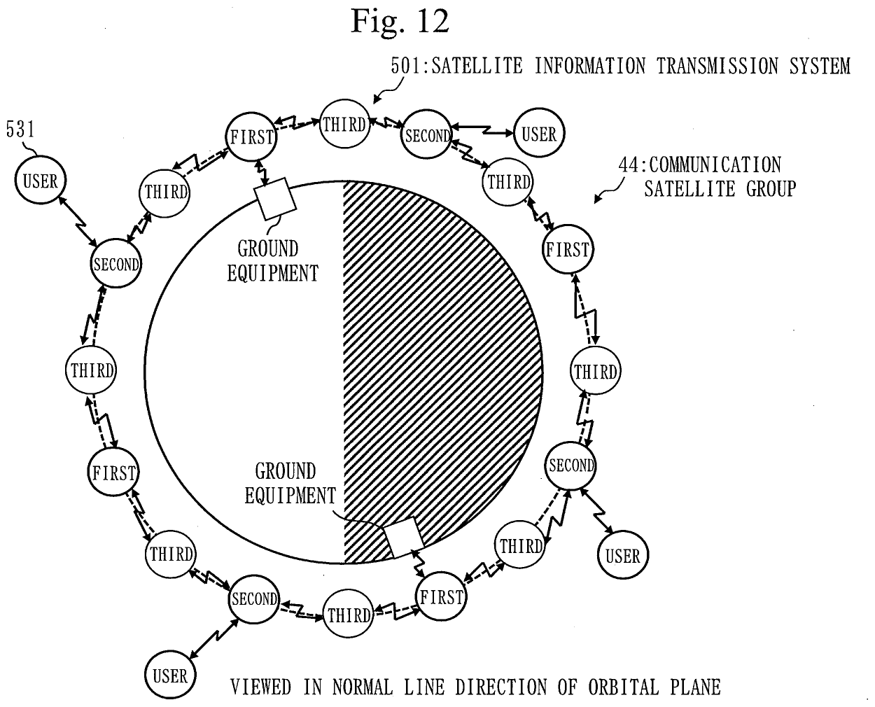

FIG. 12 is a drawing illustrating an entire configuration example of the satellite information transmission system 501 according to the present embodiment.

The basic configuration of the satellite information transmission system 501 is the same as that of the satellite watching system 500 described in Embodiment 1. The satellite information transmission system 501 is the same as the satellite watching system 500 described in Embodiment 1, except that the watching satellite 521 is replaced with the user satellite 531 and the watching center 53 is replaced with the ground equipment 702.

FIGS. 11 and 12 illustrate the first satellite 61 communicating with the ground equipment 702 as “first”, the second satellite 62 communicating with the user satellite 531 as “second”, and the third satellite 63 performing only communication with communication satellites flying in front and behind as “third”.

The satellite information transmission system 501 includes the critical infrastructure 51, which is composed of the infrastructure satellite group 510 flying in LEO, and the ground equipment 702, which exchanges information with each infrastructure satellite of the infrastructure satellite group 510.

The infrastructure satellite group 510 is composed of the communication satellite group 44 and a user satellite group 530 which is composed of user satellites 531 using the communication satellite group 44 as communication lines.

As illustrated in FIGS. 11 and 12, the communication satellite group 44 flies in an orbit with an orbital altitude and an orbital inclination angle which are features of a sun-synchronous orbit, the communication satellite group 44 orbiting an integer number of times per day in a substantially uniform arrangement. The communication satellite 401 communicates with communication satellites flying in front and behind.

The communication satellite group 44 includes the first satellite 61 communicating with the ground equipment 702, the second satellite 62 communicating with the user satellite 531, and the third satellite 63 performing only communication with communication satellites flying in front and behind. The user satellite 531 and the ground equipment 702 exchange information via the communication satellite group 44.

<Configuration Examples 1 to 4 of Communication Satellite Group 44>

A similar configuration to configuration examples 1 to 4 of the communication satellite group 44 described in the embodiment is applicable to the configuration example of the communication satellite group 44 according to the present embodiment.

<Communication Method of Communication Satellite Group 44>

A similar communication method to the communication method of the communication satellite group 44 described in the embodiment is applicable to the communication method of the communication satellite group 44 according to the present embodiment.

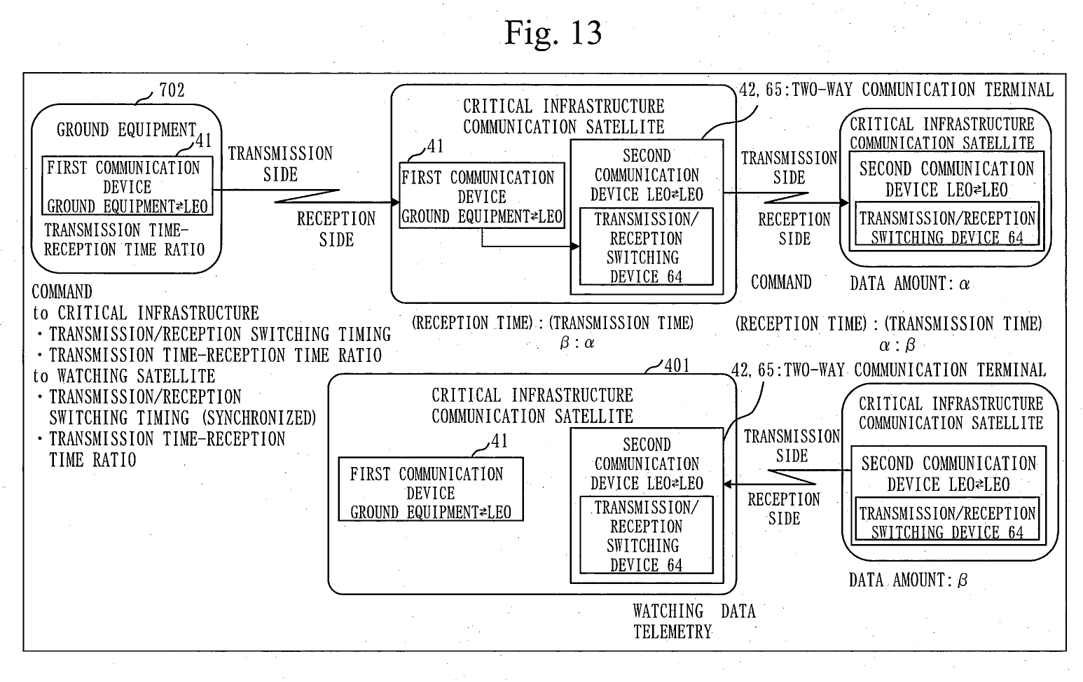

FIG. 13 is a drawing illustrating the communication method of the communication satellite group 44 according to the present embodiment.

The communication satellite 401 and the user satellite 531 include the two-way communication terminal 65 including the transmission/reception switching device 64. The ground equipment 702 operates the transmission/reception switching device 64, based on the data amount α of a command, which is transmitted to the user satellite 531, and the data amount β of user information data, which is received from the user satellite 531, so that a ratio between reception time and transmission time of the user satellite 531 becomes α versus α.

The user satellite 531 and the ground equipment 702 exchange information via each communication device of the communication satellite group 44.

### Embodiment 3

The present embodiment will mainly describe the points to be added to Embodiments 1 and 2 or the points different from Embodiments 1 and 2. Here, the same components as those in Embodiments 1 and 2 will be provided with the same reference characters and the description thereof will be omitted as appropriate.

<Ground Equipment>

The present embodiment will describe ground equipment that is used in the satellite watching system 500 or the satellite information transmission system 501 described in Embodiments 1 and 2. An example of the ground equipment is the ground equipment 701 that is included in the watching center 53, the ground equipment per infrastructure 54, or the ground equipment 702 that exchanges information with the user satellite 531.

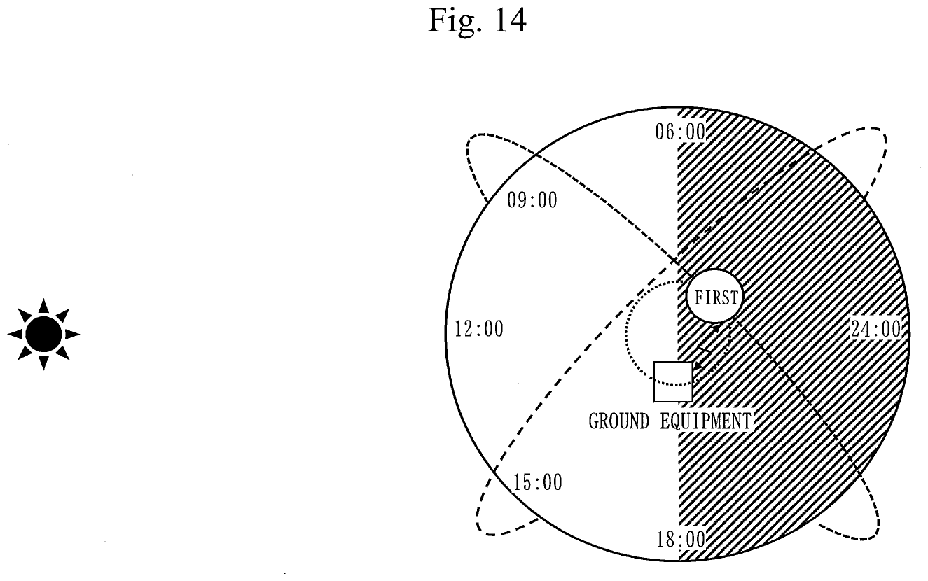

FIG. 14 is a drawing for explaining the ground equipment according to the present embodiment.

The ground equipment used in the satellite watching system 500 or the satellite information transmission system 501 described in Embodiments 1 and 2 is located at a latitude of 60° or greater and communicates with “first” which is the first satellite 61 every orbit.

The rotation period of the Earth and the revolution period of the orbital plane are different from each other. Therefore, when a communication satellite flying in the orbit at LST09:00 communicates with ground equipment, for example, ground equipment located near the equator may only be able to communicate twice: around AM09:00 and around PM09:00. On the other hand, as for ground equipment located on high latitude ground, there is an advantageous effect that a communication satellite can communicate with the ground equipment every time the communication satellite orbits the Earth even if the rotation period of the Earth and the revolution period of the orbital plane are different from each other.

### Example 1 of Communication Satellite

Example 1 of the communication satellite 401 used in the satellite watching system 500 or the satellite information transmission system 501 described in Embodiments 1 and 2 will now be described.

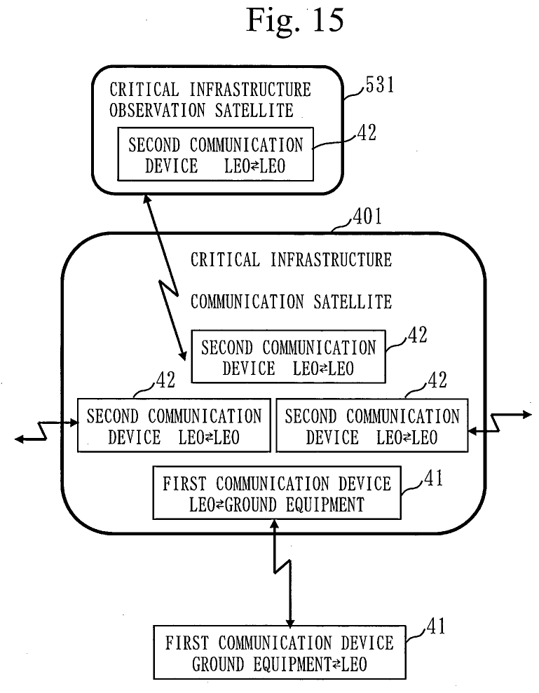

FIG. 15 is a drawing for explaining example 1 of a communication satellite according to the present embodiment.

In example 1 of the communication satellite, the communication satellite 401 includes the first communication device 41 communicating with ground equipment and three second communication devices 42 for communication between infrastructure satellites. The communication satellite 401 simultaneously communicates with a communication satellite flying in the same orbital plane and a watching satellite or a user satellite, in example 1 of the communication satellite.

If one set of first communication device communicating with ground equipment and three sets of second communication devices for communication between infrastructure satellites are provided, it is possible to simultaneously communicate with a communication satellite flying in the same orbital plane and a watching satellite or a user satellite.

Further, the communication satellite of example 1 of the communication satellite according to the present embodiment has an advantageous effect that information communicated with a user satellite can be transmitted to ground equipment in real time.

Accordingly, there is an advantageous effect that information can be exchanged between a user satellite and ground equipment even in a state in which the number of satellites flying in the same orbital plane is small in a process of building a critical infrastructure.

In addition, communication terminals can be standardized, exhibiting an advantageous effect that the total cost can be reduced.

### Example 2 of Communication Satellite

Example 2 of the communication satellite used in the satellite watching system 500 or the satellite information transmission system 501 described in Embodiments 1 and 2 will now be described.

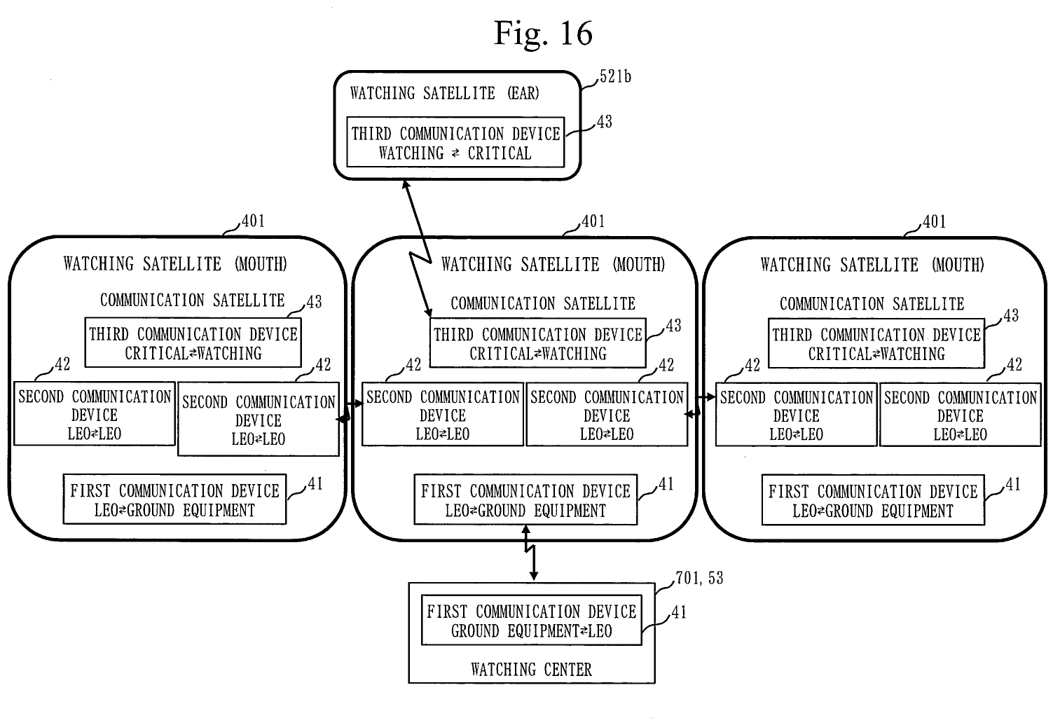

FIG. 16 is a drawing illustrating an example of the satellite information transmission system 501 according to the present embodiment.

In example 2 of the communication satellite, the communication satellite 401 includes the first communication device 41 communicating with ground equipment, the second communication device 42 for communication between infrastructure satellites, and a third communication device 43 communicating with the watching satellite 521 or the user satellite 531.

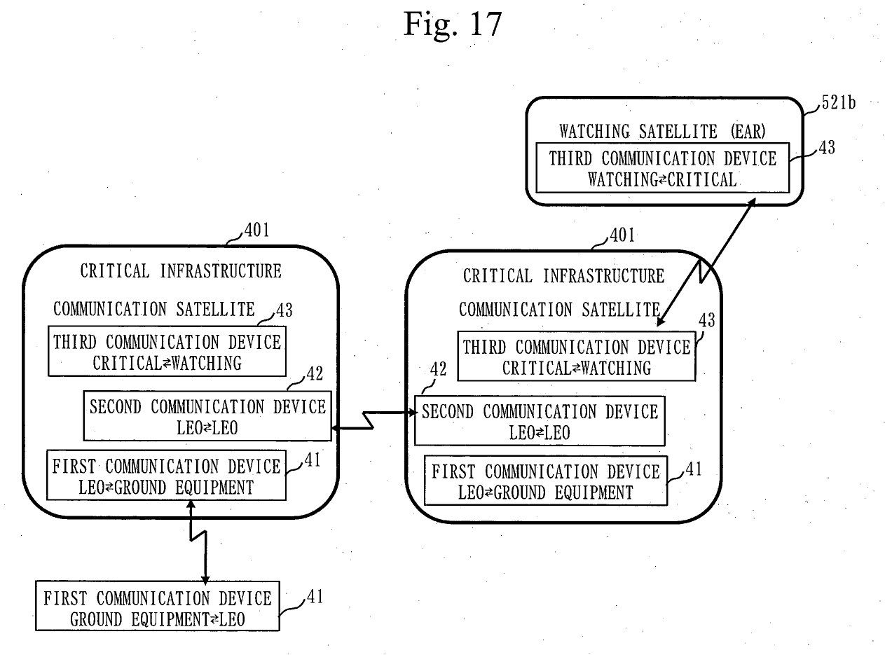

FIG. 17 is a drawing for explaining example 2 of the communication satellite according to the present embodiment.

In example 2 of the communication satellite, the communication satellite 401 includes one set of the first communication device communicating with ground equipment, two sets of the second communication devices for communication between infrastructure satellites flying in front and behind in the orbital plane, and one set of the third communication device communicating with a watching satellite or a user satellite. This provides an advantageous effect that information communicated with a user satellite can be transmitted to the ground equipment in real time.

Accordingly, there is an advantageous effect that information can be exchanged between a user satellite and ground equipment even in a state in which the number of satellites flying in the same orbital plane is small in a process of building a critical infrastructure.

In addition, by making a terminal of a watching satellite or user satellite dedicated, communication is possible even with a small terminal having a small aperture diameter, which has an advantageous effect that a watching satellite or a user satellite can be realized with a small satellite.

### Embodiment 4

The present embodiment will mainly describe the points to be added to Embodiments 1 to 3 or the points different from Embodiments 1 to 3. Here, the same components as those in Embodiments 1 to 3 will be provided with the same reference characters and the description thereof will be omitted as appropriate.

The present embodiment will describe a monitoring system 502 in which constituent satellites of a first satellite constellation 810, which monitors the Earth, flying objects, and space objects, exchange satellite information with ground equipment via constituent satellites of a second satellite constellation 820.

<Entire Configuration Example of Monitoring System 502>

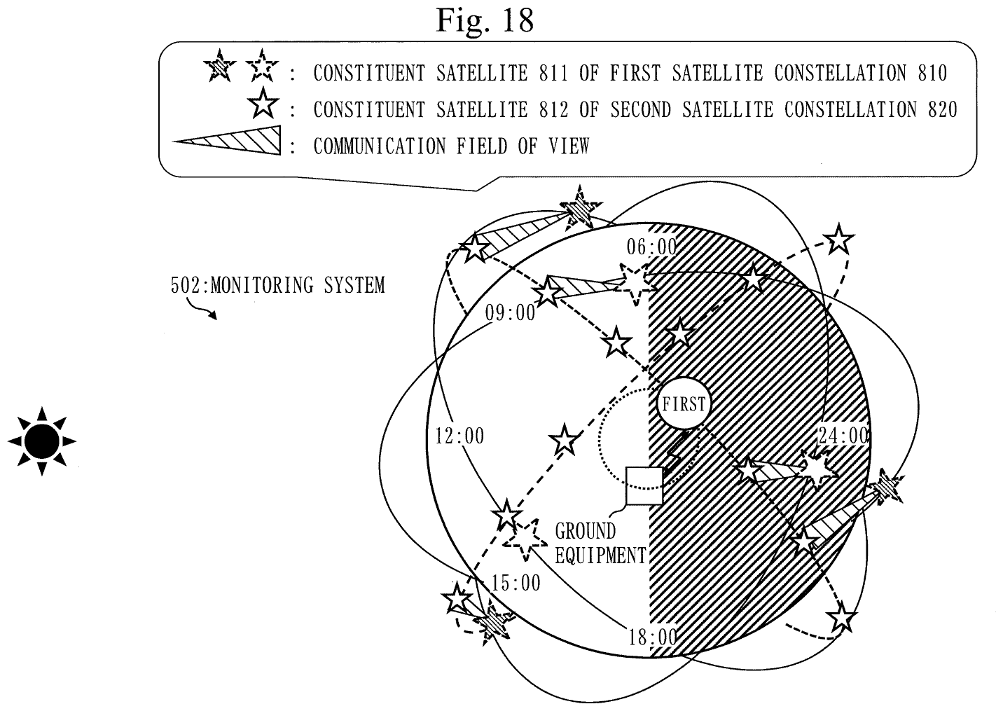

FIG. 18 is a drawing illustrating a configuration example of the monitoring system 502 according to the present embodiment.

In the monitoring system 502, constituent satellites 811 of the first satellite constellation 810, which monitors the Earth, flying objects, and space objects, exchange satellite information with ground equipment via constituent satellites 812 of the second satellite constellation 820.

The first satellite constellation 810 monitors the Earth, flying objects, and space objects by satellite groups composed of three or more constituent satellites working together.

Ground equipment exchanges information with the constituent satellites constituting the first satellite constellation 810.

The second satellite constellation 820 relays satellite information by communication satellite groups, which are composed of six or more communication satellites that fly in a sun-synchronous orbit with an orbital altitude of 800 km or higher in a substantially uniform arrangement and communicate with satellites flying in front and behind in a same orbital plane, working together. That is, the constituent satellites of the second satellite constellation 820 are communication satellite groups composed of six or more communication satellites.

The constituent satellites constituting the first satellite constellation 810 exchange information with ground equipment via the second satellite constellation 820.

In recent years, with the emergence of flying objects that glide at supersonic speed, satellite launches and flight path tracking have been expected. However, it is sometimes difficult to establish a constant communication environment in a LEO constellation.

There is also the technology of exchanging information via a data relay satellite in geostationary earth orbit. However, if the number of satellites in orbit increases and the using frequency of data relay satellite increases, communication lines are sometimes unavailable in an emergency. In addition, since information is transmitted from an LEO satellite to ground equipment via a geostationary earth orbit, a time delay may occur.

The monitoring system 502 according to the present embodiment allows constant communication of information exchange between the first satellite constellation and ground equipment via the communication satellite group established in a low-altitude sun-synchronous orbit.

Further, there is an advantageous effect that information exchange can be performed in a shorter period of time than information exchange via a data relay satellite in a geostationary earth orbit.

The number of constituent satellites, which can simultaneously exchange data, of the first satellite constellation can be increased by increasing the number of satellites of the second satellite constellation. Thus, there is an advantageous effect that monitoring data of a large number of monitoring objects can be simultaneously exchanged.

Further, the number of ground equipment which can simultaneously exchange data can be increased by increasing the number of satellites of the second satellite constellation. Thus, there is an advantageous effect that it is possible to simultaneously take action for a large number of monitoring objects.

A visible high-resolution optical monitoring device is used to monitor the Earth, flying objects, and space objects, causing a problem of limiting time available for information exchange with ground equipment located at a specific longitude when employing a sun-synchronous orbit satellite. The case employing a geostationary data relay satellite has also had the same problem. The monitoring system 502 according to the present embodiment has the advantageous effect of being available for response to emergency such as disasters because a constant communication environment via a low-orbit communication satellite group is realized.

Geostationary earth orbits are commonly used for equatorial satellites, but there is a problem in that it is difficult to perform high-resolution monitoring with geostationary satellites flying at an altitude of 36000 km. Therefore, an orbit making a plurality of equatorial orbits per day is employed, providing an advantageous effect of enabling high resolution monitoring. However, this case still has a problem in that constant communication cannot be performed only by ground equipment located at a specific longitude. Therefore, there is an advantageous effect that it is possible to realize equatorial orbiting satellite groups that can communicate constantly.

### Example 1 of First Satellite Constellation 810

Example 1 of the first satellite constellation 810 is a satellite constellation that orbits a plurality of times per day in an inclined circular orbit with an orbital altitude between 1000 km and 6000 km inclusive. In a plurality of orbital planes which are formed by a plurality of constituent satellites included in the first satellite constellation 810, normal lines are shifted from each other by equal angles in an azimuth direction and flying positions of each orbital plane are synchronously controlled.

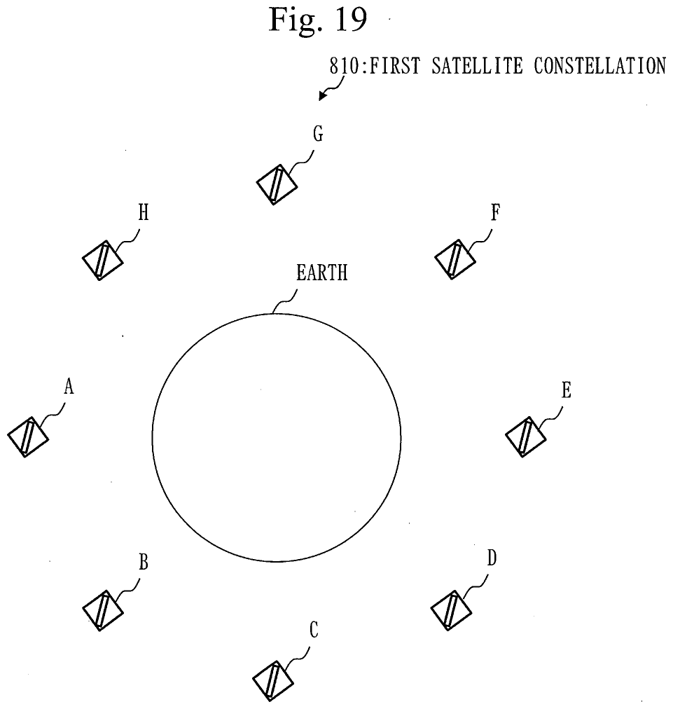

FIG. 19 is a configuration example of example 1 of the first satellite constellation 810 according to the present embodiment.

The number of times each constituent satellite orbits the Earth per day is denoted as “N”.

The first satellite constellation 810 includes N constituent satellites.

Each constituent satellite moves in an inclined circular orbit and orbits the Earth N times per day. A plane formed by an orbit along which each constituent satellite moves is called an orbital plane.

In N pieces of orbital planes which are formed by N constituent satellites, normal lines are shifted from each other by 360/N degrees in the azimuth direction. In other words, relative angles of azimuth components are shifted by 360/N degrees. The azimuth direction corresponds to a traveling direction of the constituent satellite. That is, the azimuth direction corresponds to a longitude direction and east-west direction.

Specifically, the first satellite constellation 810 includes eight constituent satellites (A to H) and forms eight orbital planes.

Each constituent satellite orbits the Earth eight times per day.

The normal lines of eight orbital planes are shifted from each other by 45 degrees of relative angles of azimuth components.

Timing at which N constituent satellites (A to H) pass through the northernmost points of respective orbital planes are synchronized with each other. In other words, N constituent satellites (A to H) pass through the northernmost points of respective orbital planes at the same time.

### Example 2 of First Satellite Constellation 810

Example 2 of the first satellite constellation 810 flies in a sun-synchronous non-frozen elliptical orbit with perigee altitude of 300 km or more and apogee altitude of 6000 km or less. In a plurality of orbital planes that are formed by a plurality of constituent satellites included in the first satellite constellation 810, azimuth direction components of respective major diameters are shifted from each other by equal angles.

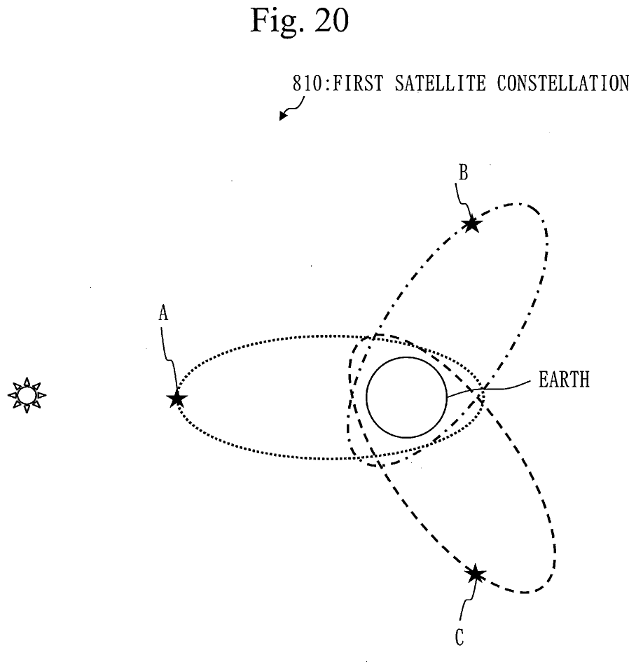

FIG. 20 is a configuration example of example 2 of the first satellite constellation 810 according to the present embodiment.

FIG. 20 illustrates example 2 of the first satellite constellation 810 viewed in a normal line direction of an orbital plane.

The first satellite constellation 810 includes a plurality of constituent satellites (A to C). Each constituent satellite orbits in a sun-synchronous elliptical orbit. Each elliptical orbit has high eccentricity and orbital inclination angle. That is, the orbit of each constituent satellite is a sun-synchronous orbit, an inclined orbit, and an elliptical orbit. Further, the elliptical orbit of each constituent satellite is a non-frozen orbit. In other words, the elliptical orbit of each constituent satellite is not a frozen orbit, and a major axis of each elliptical orbit rotates about the Earth within an orbital plane over time.

The three constituent satellites (A to C) alternately monitor target regions of the Earth from perigee, apogee, or midpoint. The midpoint is a point positioned between the perigee and the apogee.

Although in a short period of time, monitoring with high resolution can be performed at the perigee.

Although with low resolution, a long period of monitoring can be performed at the apogee.

Respective major axes of three elliptical orbits are evenly inclined by approximately 120° with respect to the circumferential direction of the orbital planes. The azimuth direction corresponds to a longitude direction, that is, the east-west direction.

The major axis of each of the elliptical orbits rotates around the sun 102, but the relative relationship among the three elliptical orbits is maintained.

### Example 3 of First Satellite Constellation 810

Example 3 of the first satellite constellation 810 orbits a plurality of times per day in an equatorial orbit, where azimuth direction components are shifted from each other by equal angles and flight positions are synchronously controlled.

In example 1 of the first satellite constellation 810 illustrated in FIG. 19, each constituent satellite moves in an inclined circular orbit and orbits the Earth N times per day.

On the other hand, in example 3 of the first satellite constellation 810, each constituent satellite moves in an equatorial orbit and orbits the Earth N times per day.

Each constituent satellite moves in an inclined circular orbit and orbits the Earth N times per day. In orbital planes on which respective constituent satellites move, azimuth direction components are shifted from each other by equal angles and flight positions are synchronously controlled.

### Example 4 of Second Satellite Constellation

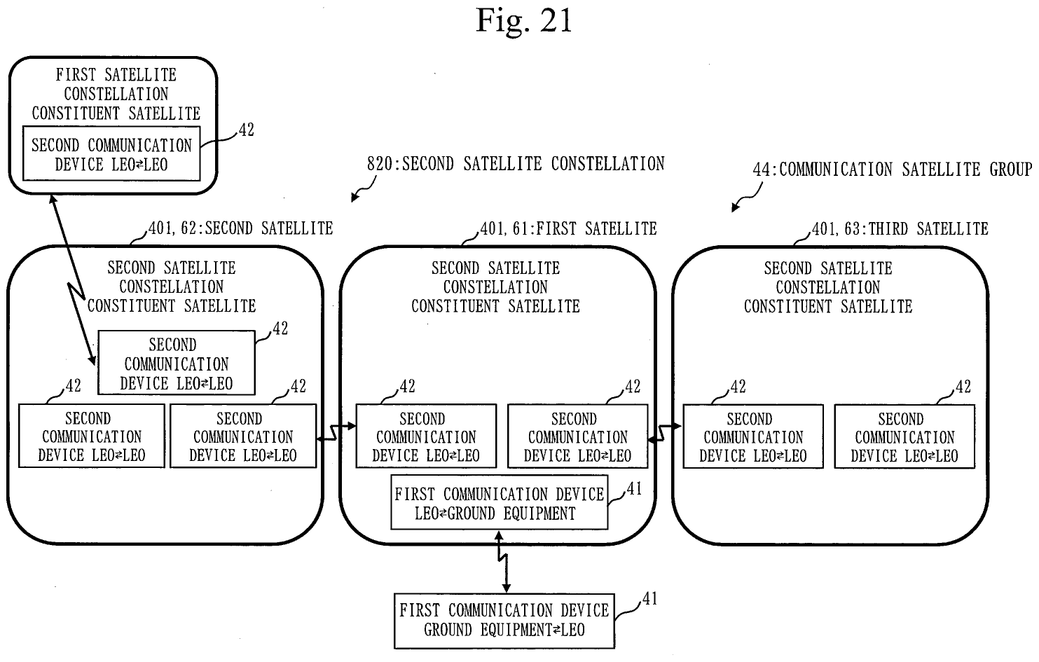

FIG. 21 is a drawing illustrating a configuration example of example 4 of the second satellite constellation 820 according to the present embodiment.

Example 4 of the second satellite constellation 820 includes the first satellite 61 communicating with ground equipment, the second satellite 62 communicating with constituent satellites constituting the first satellite constellation 810, and the third satellite 63 performing only communication with satellites flying in front and behind.

### Example 5 of Second Satellite Constellation

Example 5 of the second satellite constellation 820 relays the satellite information by communication satellite groups, which are composed of six or more communication satellites flying in a sun-synchronous orbit and in each orbital plane at LST09:00 and LST15:00, working together.

Earth observation satellites frequently use sun-synchronous orbits. Optical satellites frequently use around LST10:30 and LST13:30 at which daylight conditions are good. In addition, radar satellites frequently use LST06:00 and LST18:00 which are favorable for solar power generation.

The inscribed circle of a regular octagon is 6727 km when an orbital altitude of a communication satellite is 881 km, accordingly being able to secure communication lines with watching satellites at any LST. Here, the watching satellite may be a user satellite that uses the communication satellite group 44 as a communication line.

Therefore, if the constituent satellites of the second satellite constellation 820 are arranged in two orbital planes at LST09:00 and LST15:00 as illustrated in FIG. 18, an advantageous effect that communication can be performed with all satellite groups frequently used for earth observation is obtained.

***Other Configurations***

Ground equipment of the monitoring system 502 according to the present embodiment may be a movable body.

For example, when launch of a flying object gliding at supersonic speed is detected, it is reasonable to transmit information to a movable body, such as an aircraft, an UAV (unmanned aerial vehicle), a ship, and a vehicle, which directly takes response action, so as to conduct the response action in a short period of time.

### Embodiment 5

The present embodiment will mainly describe the points to be added to Embodiments 1 to 4 or the points different from Embodiments 1 to 4. Here, the same components as those in Embodiments 1 to 4 will be provided with the same reference characters and the description thereof will be omitted as appropriate.

The present embodiment will mainly describe a communication method of the satellite information transmission system 501.

### Communication Method Example 1 of Satellite Information Transmission System 501

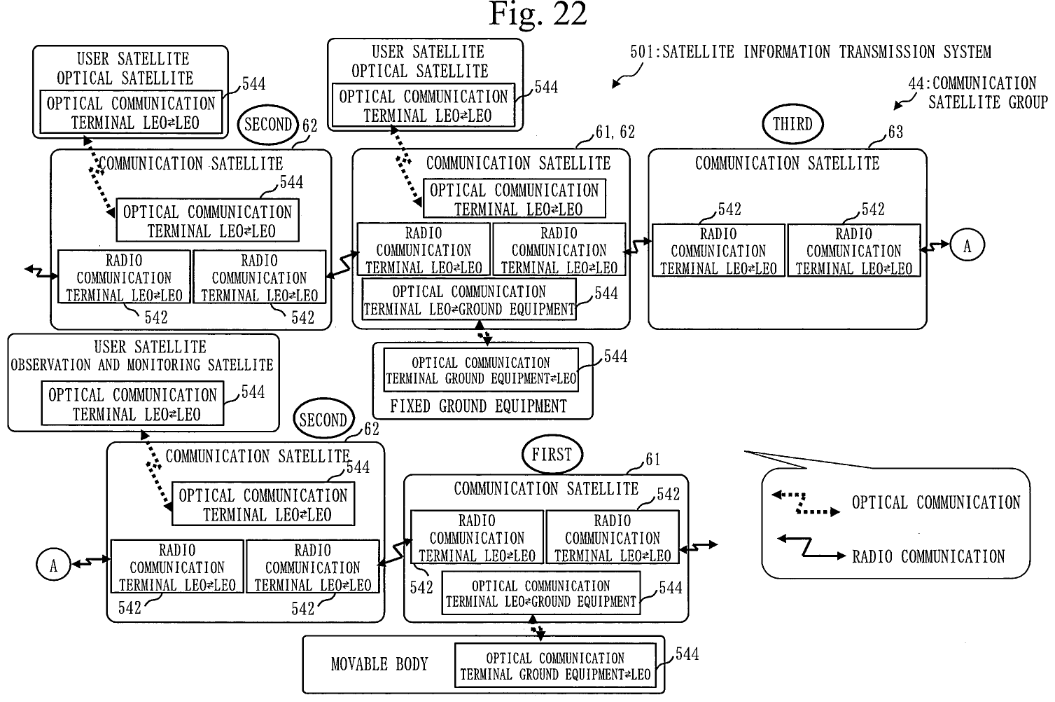

FIG. 22 is a drawing illustrating a configuration example of the satellite information transmission system 501 according to the present embodiment.

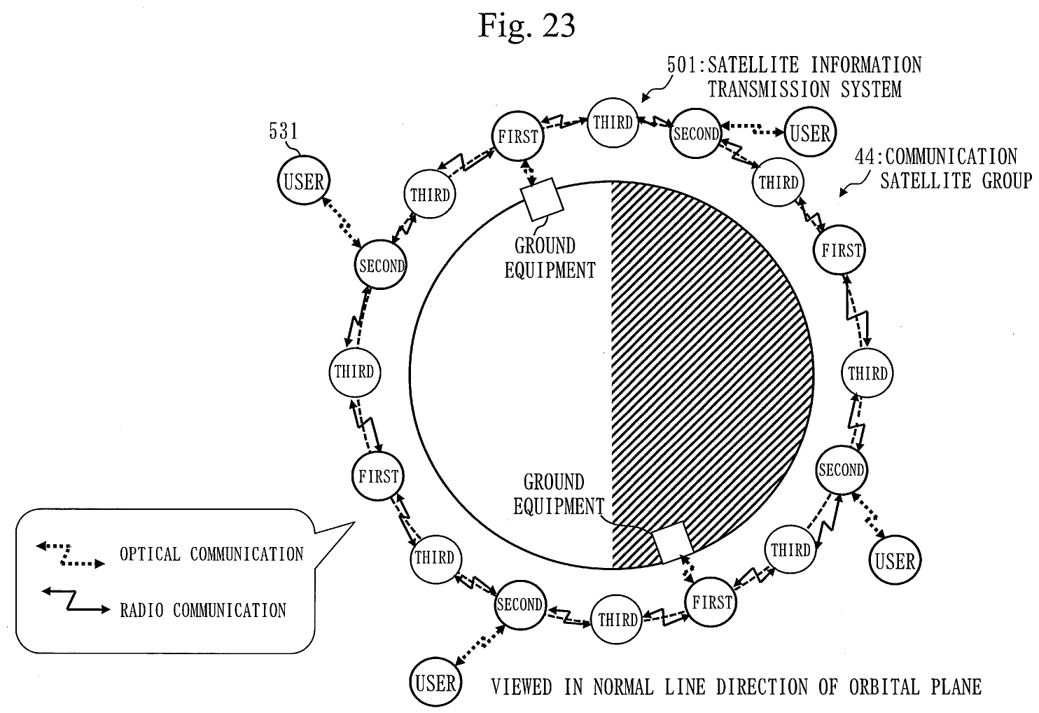

FIG. 23 is a drawing illustrating an entire configuration example of the satellite information transmission system 501 according to the present embodiment.

The satellite information transmission system 501 according to the present embodiment relays satellite information between the user satellites 531, which constitute a user satellite group orbiting the Earth, and the ground equipment 702.

The satellite information transmission system 501 includes the communication satellite group 44 that is composed of six or more communication satellites. The six or more communication satellites orbit in sun-synchronous orbits in an earth orbit (LEO) at an orbital altitude between 500 km and 2000 km inclusive in a substantially uniform arrangement and communicate with communication satellites flying in front and behind in the same orbital plane.

The communication satellite 401 communicates with communication satellites flying in front and behind.

In communication method example 1 of the satellite information transmission system 501, the communication satellite group 44 includes the first satellite 61 optically communicating with the ground equipment 702, the second satellite 62 optically communicating with the user satellite 531, and the third satellite 63 performing only communication with communication satellites flying in front and behind. In the communication satellite group 44, radio communication is performed between communication satellites flying in front and behind.

Optical communication is performed by optical communication terminals 544. Radio communication is performed by radio communication terminals 542.

Optical communication has an advantage of being able to transmit large amounts of data. However, optical axes need to be precisely aligned between satellites and accordingly, it is necessary to perform high-precision pointing control of two axes of both a user satellite and a communication satellite.

Since the relative positional relationship between ground equipment and communication satellites fluctuates greatly, it is necessary to control the pointing direction, which fluctuates from moment to moment, with high precision in real time.

In addition, also in a case where the relative positional relationship between a user satellite and a communication satellite fluctuates greatly, it is similarly necessary to control the pointing direction, which fluctuates from moment to moment, with high precision in real time.

When the relative positional fluctuation is large, communication available time is also limited, requiring large-capacity communication.

If a single satellite is to realize optical communication of communication between front and rear communication satellites, communication with user satellites, and communication with ground equipment all at the same time, it is necessary to simultaneously align optical axes of different targets with high precision. This poses a problem in that the technical difficulty is high and risk of communication disruption is also high.

In radio communications, if high-speed and large-capacity data transmission over long distance is to be achieved, central axes of main beams of radio waves need to be aligned with high precision, as in the optical communications described above. However, in proximity communication, low-speed communication, or communication with limited data amount, communication without high-precision axis alignment can be achieved with a fixed antenna or a non-directional antenna.

In the above-mentioned front and rear communication in the communication satellite group according to the present embodiment, inter-satellite distance is limited and relative angle variation between front and rear satellites is small. Therefore, radio communication by a fixed antenna can be realized instead of the optical communication requiring high-precision pointing control or high-speed and large-capacity radio communication.

Further, communication can be performed at all times, providing an advantageous effect that large-capacity communication can be performed if taking time even in low-speed communication.

If radio communication that does not require high-precision pointing control is realized between front and rear satellites, the number of communication targets for simultaneous high-precision pointing control is limited to one both when the first satellite optically communicates with ground equipment and when the third satellite optically communicates with a user satellite. Thus, there is an advantageous effect that pointing control is easy and the risk of communication disruption can be suppressed to a sufficiently low level.

<Communication Method Example 2 of Satellite Information Transmission System 501>

In communication method example 2 of the satellite information transmission system 501, spectrum of radio waves between communication satellites flying in front and behind is spread.

There is a problem of a risk that when front and rear satellites flying in the same orbit communicate by radio waves, a plurality of satellites flying in front or behind cause radio interference or false transmissions. If the spectrum is spread and only desired satellite signals are restored, an advantageous effect that radio interference and false transmission can be avoided is obtained.

<Communication Method Example 3 of Satellite Information Transmission System 501>

In communication method example 3 of the satellite information transmission system 501, communication satellites include the two-way communication terminal 65 with transmission/reception switching function for communicating with communication satellites flying in front and behind.

When communication satellites include a terminal for transmission to a front satellite and a terminal for reception from a rear satellite and all the satellites communicate with front and rear satellites in the same orbit, a satellite information transmission system is established. However, there is a problem of a high risk that communication is disrupted on a preparation stage for putting satellites into orbit or when a failure occurs on the orbit. The provision of the two-way communication terminal 65 with transmission/reception switching function provides an advantageous effect that satellite information can be transmitted even when all satellites are not aligned on the orbit.

<Communication Method Example 4 of Satellite Information Transmission System 501>

In communication method example 4 of the satellite information transmission system 501, communication satellites employ different polarized waves for transmission and reception.

The relative positions and relative attitudes with respect to front and rear satellites are maintained and therefore there is an advantageous effect that the risk of radio interference or false transmission can be eliminated by employing different polarized waves for transmission and reception.

<Communication Method Example 5 of Satellite Information Transmission System 501>

In communication method example 5 of the satellite information transmission system 501, the communication satellite group 44 includes a fourth satellite that optically communicates with ground equipment and optically communicates with a user satellite.

As for satellite information with urgency, if one satellite performs information exchange with a user satellite and ground equipment at the same time, delay time can be advantageously suppressed to the minimum.

Since it is necessary to perform high-precision pointing control with two targets at the same time, the technical difficulty is high, resulting in a high-cost system. However, there is an advantageous effect that practical use is much easier and the cost is low compared to a configuration in which communication with front and rear satellites is also optical communication and high-precision pointing control is performed with four different targets.

As for the case with no urgency, since flying positions on which a user satellite and ground equipment can communicate simultaneously are limited, if one satellite includes a function to communicate with both of the user satellite and the ground equipment and communication is performed in a time-divisional manner, the number of targets to which the high-precision pointing control is simultaneously performed can be limited to one.

<Communication Method Example 6 of Satellite Information Transmission System 501>

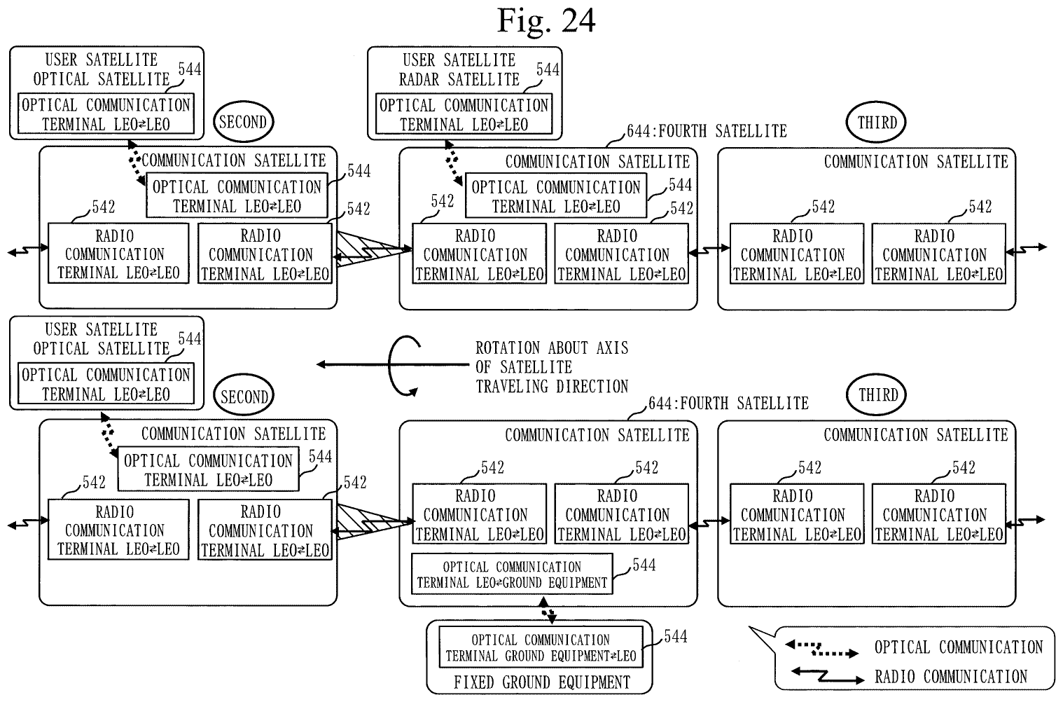

FIG. 24 is a drawing illustrating communication method example 6 of the satellite information transmission system 501 according to the present embodiment.

A fourth satellite 644 shares optical communication with the ground equipment 702 and optical communication with the user satellite 531 at the same optical communication terminal 544. The fourth satellite 644 rotates about the axis of satellite traveling direction and performs the optical communication with the ground equipment 702 and the optical communication with the user satellite 531 in a time-divisional manner.

As for the case with no urgency, since flying positions on which a user satellite and ground equipment can communicate simultaneously are limited, if one satellite includes a function to communicate with both of the user satellite and the ground equipment and communication is performed in a time-divisional manner, the number of targets to which the high-precision pointing control is simultaneously performed can be limited to one.

Further, if terminals for communicating with user satellites and ground equipment are standardized, an effect of reducing costs is obtained.

It is effective when a sufficient number of communication satellites fly in orbit and do not deviate from a radio field of view even if the communication satellites rotate about the axis of the traveling direction.

***Other Configurations***

The ground equipment 702 according to the present embodiment may be a movable body.

When satellite information with urgency needs to be transmitted from a fixed ground equipment to a movable body, an advantageous effect that delay time can be suppressed to the minimum is obtained if the satellite information is directly transmitted from the communication satellite to the movable body. This is effective in cases where even time delay in seconds can lead to increased risk, such as a case where a response action is ordered after detecting launch of a flying object.

The communication satellite group 44 may include the first satellite 61 communicating with the ground equipment 702 by radio waves, the second satellite 62 optically communicating with the user satellite 531, and the third satellite 63 performing only communication with communication satellites flying in front and behind. Further, the communication satellite group 44 performs radio communication between communication satellites flying in front and behind. Optical communication between a communication satellite and ground equipment has a problem in that communication is impossible in the presence of clouds. Therefore, the employment of radio communication provides an advantageous effect that availability is raised in a case that the ground equipment 701 using the satellite information transmission system of communication method example 1 is in an area with high cloud coverage.

### Embodiment 6

The present embodiment will mainly describe the points to be added to Embodiments 1 to 5 or the points different from Embodiments 1 to 5. Here, the same components as those in Embodiments 1 to 5 will be provided with the same reference characters and the description thereof will be omitted as appropriate.

The present embodiment will mainly describe the configurations of a communication satellite constellation, a satellite constellation, and a satellite information transmission system that use satellites flying in the sun-synchronous orbits described in Embodiments 1 to 5.

<Configuration of Artificial Satellite 80>

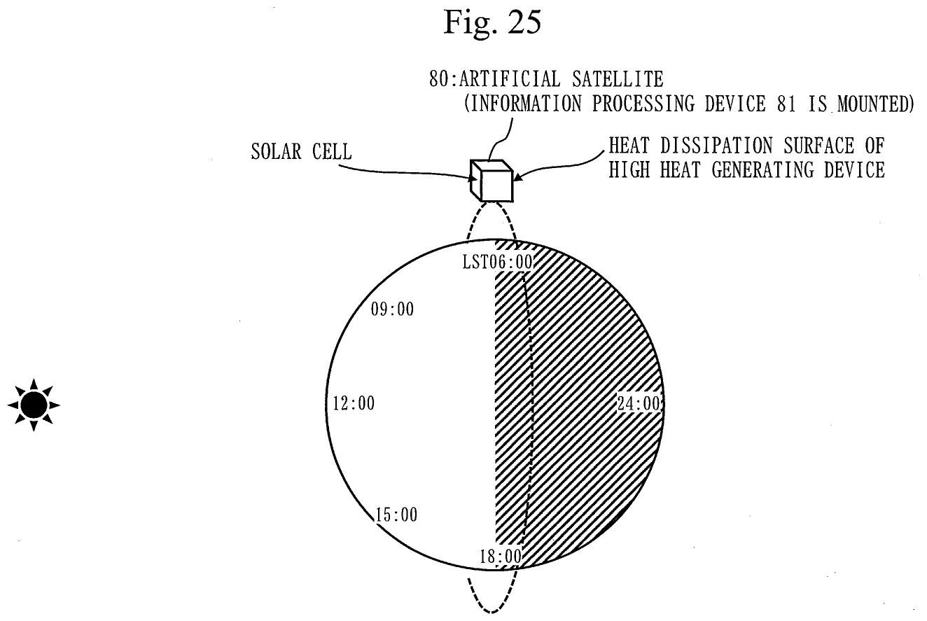

FIG. 25 is a drawing illustrating a configuration example of an artificial satellite 80 according to the present embodiment.

The artificial satellite 80 according to the present embodiment includes at least one of a computing machine or a super computer, which has AI (Artificial Intelligence), and a cloud server or an edge server, as an information processing device 81.

The artificial satellite 80 flies in the sun-synchronous orbit at LST06:00 or LST18:00. Here, the solar cell of the artificial satellite 80 is oriented to a sunlight incident side, and the artificial satellite 80 has a heat dissipation surface of the information processing device 81 on an opposite side of sunlight incidence. The solar cell of the artificial satellite 80 is oriented to the sunlight incident side, and the artificial satellite 80 has the heat dissipation surface of, for example, a computing machine or an edge server on the opposite side of sunlight incidence.

A sun-synchronous orbit is a kind of a polar orbit passing over a polar region. In a sun-synchronous orbit, the rotation period of the orbital plane about the north-south axis is synchronized with the revolution period of the Earth. Therefore, in a sun-synchronous orbit, the incident angle of the Sun with respect to the orbital plane is constant throughout a year.

The normal vector of the orbital plane is in an orbit that is oriented to the direction of the Sun in the orbit at LST06:00 or LST18:00. Accordingly, even a low-orbit satellite is not in the shadow of the Earth and is constantly illuminated by sunlight. Strictly speaking, the normal vector is inclined from the direction of the Sun due to the inclination of the Earth's axis, but the influence thereof is negligible.

Power of computing machines and servers, which play the role of brains in watching satellites, has been increased with the emergence of AI and the increase in server capacity and speed, generating an issue of heat dissipation measures as high heat generating devices.

The sun-synchronous orbit at LST06:00 or LST18:00 is also called dawn dusk orbit. In the dawn dusk orbit, even a low-orbit satellite is not in the shadow of the Earth and can generate electricity by solar cells at all times. In addition, in the dawn dusk orbit, the opposite side of sunlight incidence is always oriented in deep space and accordingly, the dawn dusk orbit is excellent in heat dissipation performance obtained by radiative cooling. Thus, the dawn dusk orbit has an advantageous effect to be able to secure high power and dissipate heat from high heat generating devices.

The information processing device 81 is an example of the high heat generating device.

In addition, with the recent increase in scale and speed of cloud computing, the cloud environment in ground systems also faces an issue of increasing power and heat dissipation measures for high heat generating device. In this view, distributed computing is performed by regarding the artificial satellite 80, including an edge server, as JOT, providing an advantageous effect that a load on the ground system is reduced to contribute SDGs.

Further, centralized computing equipment is prepared in outer space by providing a super computer or a cloud server to the artificial satellite 80, providing an advantageous effect that a load on the ground system is reduced to contribute SDGs.

IOT is an abbreviation for Internet of Things. SDGs is an abbreviation for Sustainable Development Goals.

<Configuration Example of Communication Satellite Constellation 801>

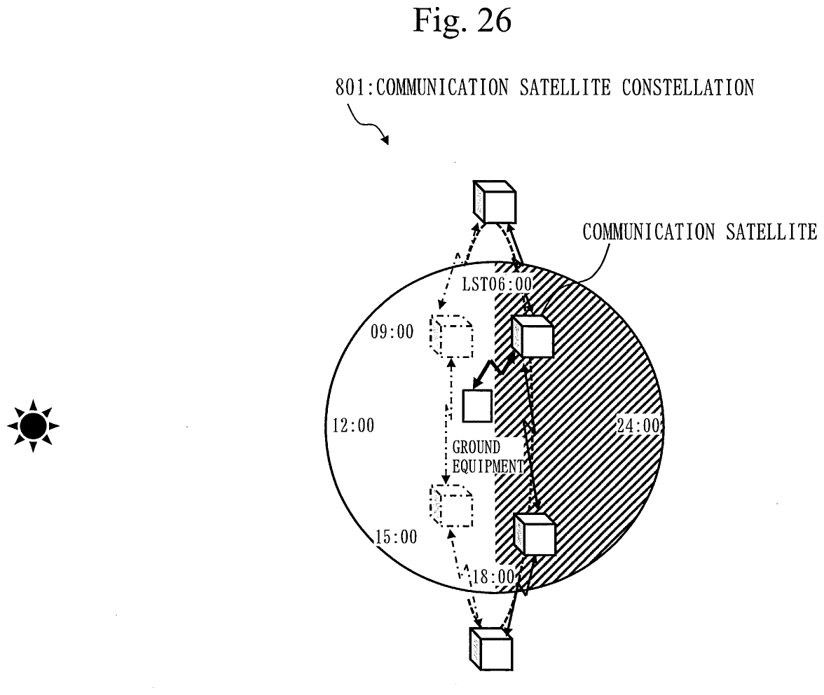

FIG. 26 is a drawing illustrating a configuration example of a communication satellite constellation 801 according to the present embodiment.

The communication satellite constellation 801 is a satellite constellation flying in the sun-synchronous orbit at LST06:00 or LST18:00.

The communication satellite constellation 801 includes a communication satellite including a communication device for communicating with the ground. The communication satellite is an example of the artificial satellite 80.

Further, the communication satellite constellation 801 includes communication devices that allow communication between communication satellites flying in front and behind in the same orbital plane to form an annular communication network.

According to the communication satellite constellation 801, fixed solar cells can constantly generate electricity in communication satellites, providing an advantageous effect to be able to realize communication satellites with low cost.

<Configuration Example of Satellite Constellation 802>

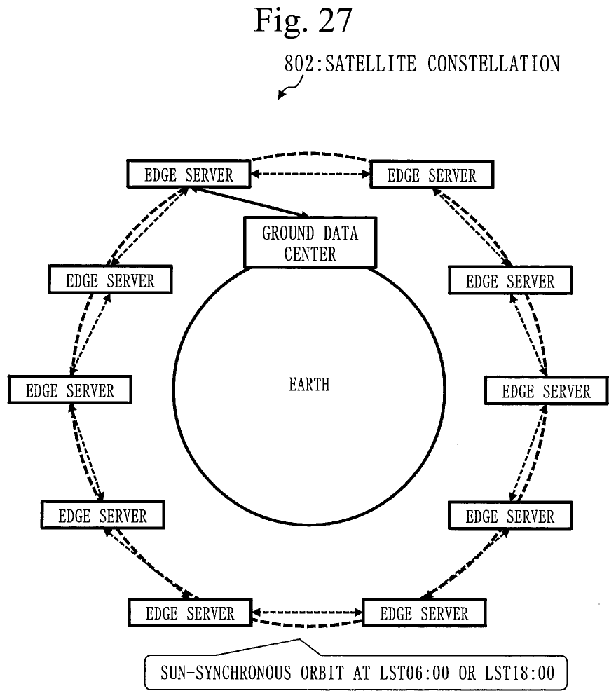

FIG. 27 is a drawing illustrating a configuration example of a satellite constellation 802 according to the present embodiment.

In FIG. 27, satellites include edge servers in the satellite constellation 802. The satellite constellation 802 flies in the sun-synchronous orbit at LST06:00 or LST18:00.

The satellite constellation 802 includes satellites. The satellite is an example of the artificial satellite 80.

The satellite includes at least one of a computing machine or a super computer, which has satellite AI, and a cloud server or an edge server, as the information processing device 81. In addition, the solar cell in the satellite is oriented to the sunlight incident side, and the satellite has the heat dissipation surface of the information processing device 81 on the opposite side of sunlight incidence. The solar cell in the satellite is oriented to the sunlight incident side, and the satellite has a heat dissipation surface of, for example, a computing machine or an edge server on the opposite side of sunlight incidence.

The satellite includes a communication device for communicating with the ground.

The satellite constellation 802 includes communication devices that allow communication between satellites flying in front and behind in the same orbital plane to form an annular communication network. That is, the satellites constituting the satellite constellation 802 include communication devices that allow communication between satellites flying in front and behind in the same orbital plane to form an annular communication network.

The sun-synchronous orbit passes through the polar region on every orbit. Thus, according to the satellite constellation 802, there is an advantageous effect that all satellites can constantly communicate with a ground data center located in high latitude zone via the annular communication network.

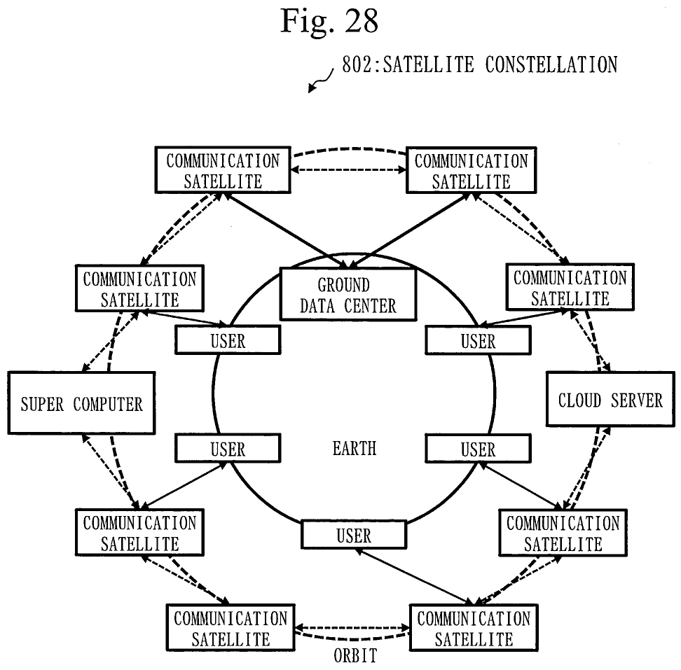

FIG. 28 is a drawing illustrating another example of the configuration of the satellite constellation 802 according to the present embodiment.

In FIG. 28, the satellite constellation 802 is composed of communication satellites, a satellite including a super computer, and a satellite including a cloud server. According to the satellite constellation 802 of FIG. 28, results obtained through on-orbit analysis processing can be transmitted to users on the ground, providing an advantageous effect to be able to reduce a load on the ground system.

<Configuration Example of Example 1 of Satellite Information Transmission System 503>

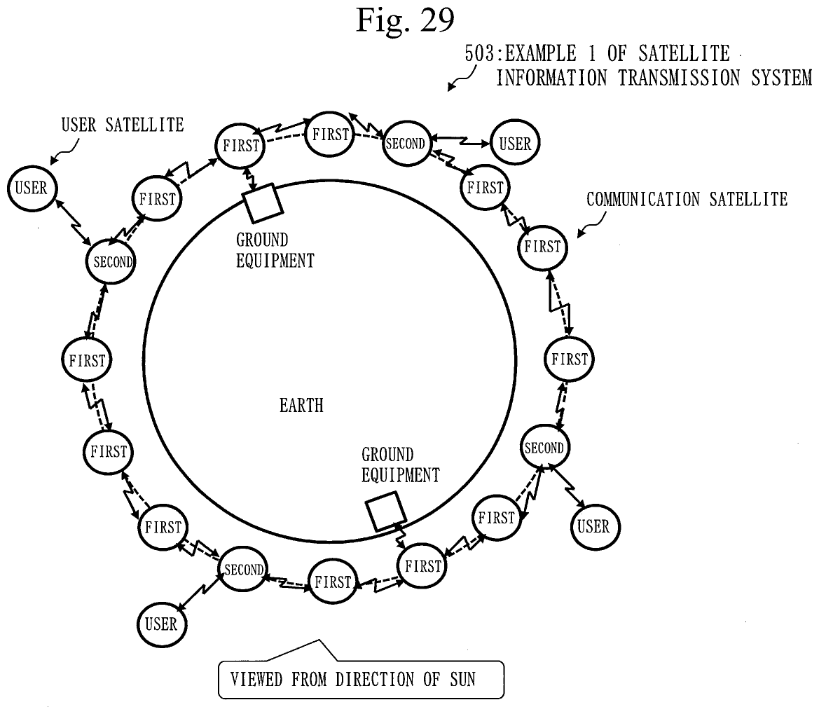

FIG. 29 is a drawing illustrating a configuration example of example 1 of a satellite information transmission system 503 according to the present embodiment.

FIG. 29 illustrates a state in which the satellite information transmission system 503 is viewed from the direction of the Sun.

Example 1 of the satellite information transmission system 503 is composed of a user satellite group, a communication satellite group, and ground equipment.

The user satellite group is composed of user satellites flying in the earth orbit (LEO) with an orbital altitude between 500 km and 2000 km inclusive.

The communication satellite group is composed of a plurality of communication satellites flying in the sun-synchronous orbit at LST06:00 or LST18:00.

Each satellite of the communication satellite group is an example of the artificial satellite 80.

The communication satellite group includes the first satellite communicating with the ground equipment and the second satellite communicating with user satellites. The communication satellite group communicates with communication satellites flying in front and behind.

The user satellite and the ground equipment exchange information via the communication satellite group.

A satellite in the sun-synchronous orbit can communicate with ground equipment only in the same time zone of LST from the low latitude zone to the middle latitude zone due to the effect of the rotation of the Earth. On the other hand, in a range in which the field of view is secured from above the polar region, communication with ground equipment is possible at all times without being limited to the LST time zone. Therefore, if an annular communication network is formed through communication between front and rear satellites and a satellite passing near the polar region communicates with the ground equipment as a representative, communication with the ground equipment is possible at all times.

User satellites constitute a flying object tracking system that performs launch detection and tracking of flying objects. Information of user satellites needs to transmit satellite information quickly in an emergency.

According to example 1 of the satellite information transmission system 503, there is an advantageous effect that satellite information can be quickly transmitted to ground equipment, located in high latitude zone, via the annular communication network.

Here, user satellites constituting the flying object tracking system include a monitoring satellite provided with an infrared detection device and a communication satellite group formed in an inclined orbit.

<Configuration Example of Example 2 of Satellite Information Transmission System 503>

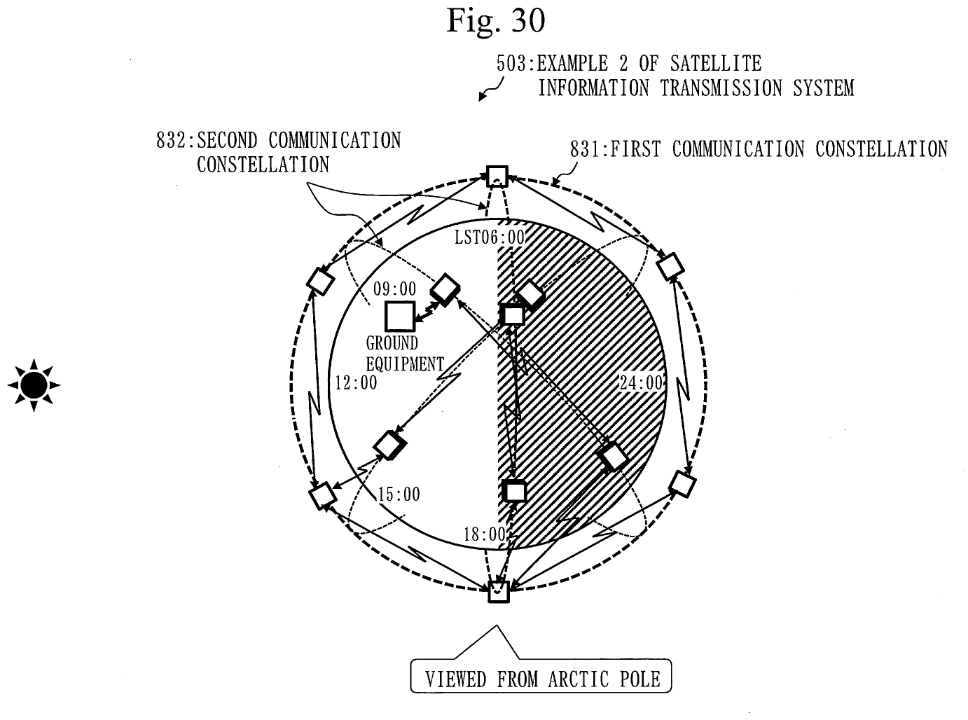

FIG. 30 is a drawing illustrating a configuration example of example 2 of the satellite information transmission system 503 according to the present embodiment.

FIG. 30 illustrates a state in which the satellite information transmission system 503 is viewed from the direction of the Arctic pole.

Example 2 of the satellite information transmission system 503 is composed of a first communication constellation 831, a second communication constellation 832, and ground equipment.

The first communication constellation 831 flies in an equatorial orbit. Further, in the first communication constellation 831, a plurality of satellites, which include first communication devices communicating with front and rear satellites in the traveling direction on the same orbital plane, form an annular communication network.

The second communication constellation 832 flies in the sun-synchronous orbit. Further, in the second communication constellation 832, a plurality of satellites, which include first communication devices communicating with front and rear satellites in the traveling direction on the same orbital plane, form an annular communication network.

Each satellite of the first communication constellation 831 and the second communication constellation 832 includes the second communication device with which the first communication constellation 831 and the second communication constellation 832 communicate.

Each satellite of the first communication constellation 831 and the second communication constellation 832 transmits satellite information to ground equipment via the first communication constellation 831 and the second communication constellation 832.

Alternatively, each satellite of the first communication constellation and the second communication constellation may include a communication device which communicates with a user satellite.

The user satellite may transmit satellite information to ground equipment via the first communication constellation 831 and the second communication constellation 832.

Satellite information acquired by a satellite flying in an equatorial orbit is sometimes transmitted to ground equipment that is located from a middle latitude zone to a high latitude zone. In this case, it is reasonable that equatorial satellites forming an annular communication network in a longitude direction and sun-synchronous satellites forming an annular communication network in a latitude direction communicate with each other.

If ground equipment is located in the high latitude zone where a sun-synchronous satellite can secure a communication field of view when the sun-synchronous satellite passes through the polar region, an advantageous effect that satellite information acquired by the equatorial satellite can be transmitted to the ground equipment almost in real time only in one sun-synchronous orbital plane is obtained.

Here, it goes without saying that each of the first communication constellation and the second communication constellation may include communication devices for communication with user satellites.

<Configuration Example of Example 3 of Satellite Information Transmission System 503>

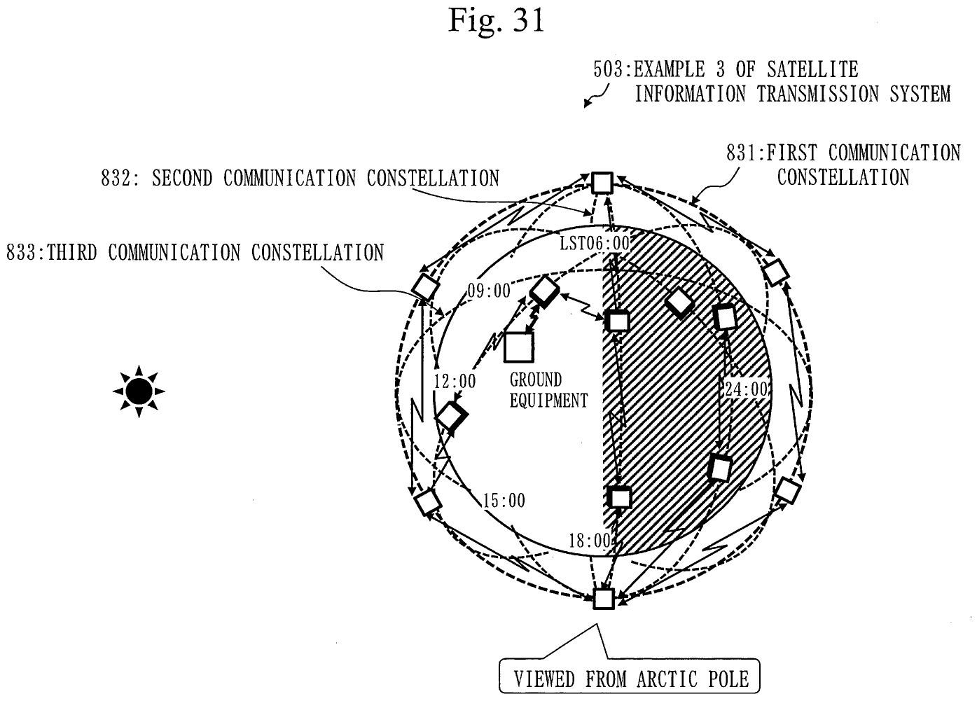

FIG. 31 is a drawing illustrating a configuration example of example 3 of the satellite information transmission system 503 according to the present embodiment.

FIG. 31 illustrates a state in which the satellite information transmission system 503 is viewed from the direction of the Arctic pole.

Example 3 of the satellite information transmission system 503 is composed of the first communication constellation 831, the second communication constellation 832, a third communication constellation 833, and ground equipment.

The first communication constellation 831 flies in an equatorial orbit. Further, in the first communication constellation 831, a plurality of satellites, which include first communication devices communicating with front and rear satellites in the traveling direction on the same orbital plane, form an annular communication network.

The second communication constellation 832 flies in the sun-synchronous orbit. Further, in the second communication constellation 832, a plurality of satellites, which include first communication devices communicating with front and rear satellites in the traveling direction on the same orbital plane, form an annular communication network.

The third communication constellation 833 flies in an inclined orbit. Further, in the third communication constellation 833, a plurality of satellites, which include first communication devices communicating with front and rear satellites in the traveling direction on the same orbital plane, form an annular communication network.

Each satellite of the first communication constellation 831, the second communication constellation 832, and the third communication constellation 833 includes the second communication devices.

The second communication device is a communication device with which the first communication constellation and the second communication constellation communicate, or the second communication constellation and the third communication constellation communicate, or the third communication constellation and the first communication constellation communicate.

Each satellite of the first communication constellation 831, the second communication constellation 832, and the third communication constellation 833 transmits satellite information to ground equipment via at least two of the first communication constellation 831, the second communication constellation 832, and the third communication constellation 833.

Alternatively, each satellite of the first communication constellation, the second communication constellation, and the third communication constellation 833 may include a communication device which communicates with a user satellite.

The user satellite may transmit satellite information to ground equipment via at least two of the first communication constellation 831, the second communication constellation 832, and the third communication constellation 833.

Satellite information acquired by a satellite in an equatorial orbit is sometimes transmitted to ground equipment located in a middle latitude zone. In this case, it is reasonable that inclined orbit satellites forming an annular communication network in an inclined orbit and flying in the middle latitude zone in the longitude direction, equatorial satellites forming an annular communication network in the longitude direction, and sun-synchronous satellites forming an annular communication network in the latitude direction communicate with each other.

For example, when ground equipment is located at 35 degrees north latitude, an inclined orbit satellite with an orbit inclination angle of 35 degrees flies over the ground equipment in the longitude direction, which has an advantageous effect of ensuring a longer communication time with the ground equipment. If an inclined orbit satellite group which has a plurality of orbital planes whose normal vectors are distributed in the longitude direction is provided as the inclined orbit satellite group, an advantageous effect that satellite information acquired by an equatorial satellite can be transmitted to the ground equipment almost in real time is obtained.

<Configuration Example of Example 4 of Satellite Information Transmission System 503>

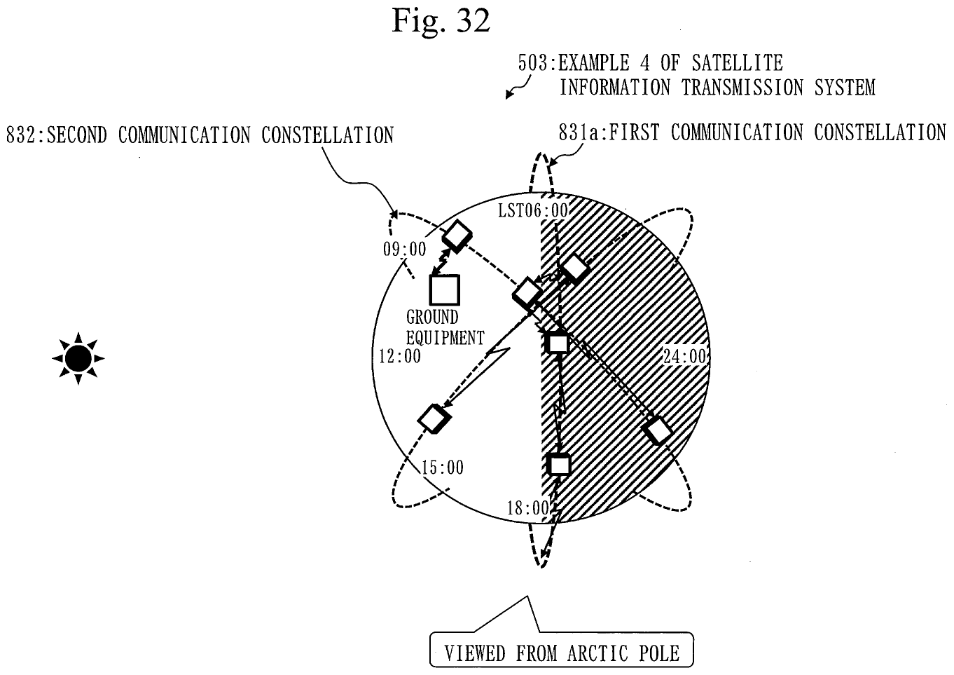

FIG. 32 is a drawing illustrating a configuration example of example 4 of the satellite information transmission system 503 according to the present embodiment.

FIG. 32 illustrates a state in which the satellite information transmission system 503 is viewed from the direction of the Arctic pole.

Example 4 of the satellite information transmission system 503 is composed of a first communication constellation 831a, the second communication constellation 832, and ground equipment.

The first communication constellation 831a flies in the sun-synchronous orbit. Further, in the first communication constellation 831a, a plurality of satellites, which include first communication devices communicating with front and rear satellites in the traveling direction on the same orbital plane, form an annular communication network.

The second communication constellation 832 flies in the sun-synchronous orbit at different LST from that of the first communication constellation 831a. Further, in the second communication constellation 832, a plurality of satellites, which include first communication devices communicating with front and rear satellites in the traveling direction on the same orbital plane, form an annular communication network.

Each satellite of the first communication constellation 831a and the second communication constellation 832 includes the second communication device with which the first communication constellation 831a and the second communication constellation 832 communicate when passing near the polar region.

Each satellite of the first communication constellation 831a and the second communication constellation 832 transmits satellite information to ground equipment via the first communication constellation 831a and the second communication constellation 832.

A sun-synchronous orbit is a polar orbiting satellite passing over the vicinity of the polar region. Accordingly, the first communication constellation 831a and the second communication constellation 832, forming annular communication networks, include satellites capable of communicating over the vicinity of the polar regions. Transmitting satellite information to annular communication networks of communication constellations of different LSTs provides an advantageous effect that satellite information can be transmitted at desired time zone irrespective of a latitude zone where ground equipment is located.

<Configuration Example of Example 5 of Satellite Information Transmission System 503>

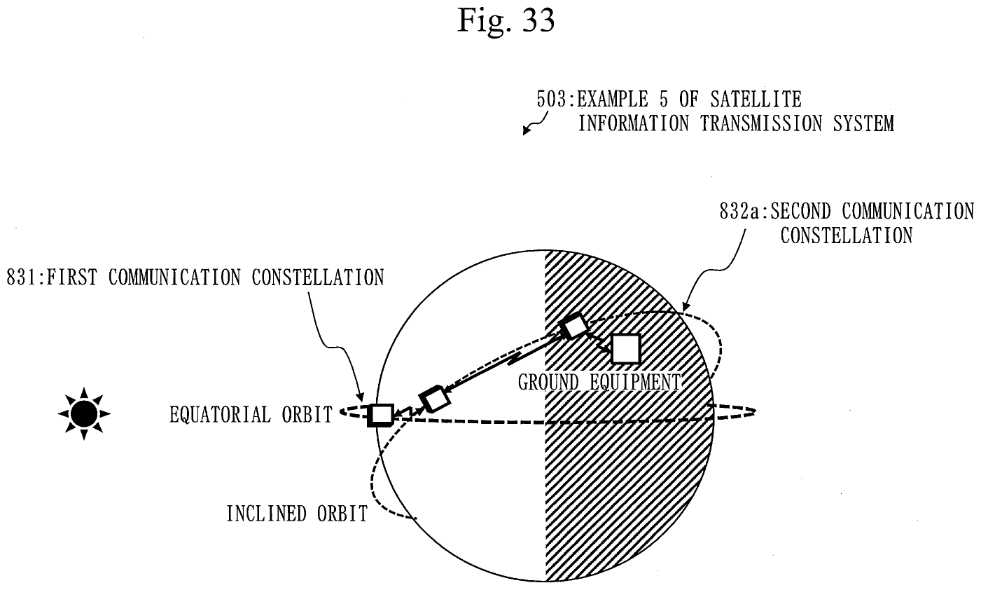

FIG. 33 is a drawing illustrating a configuration example of example 5 of the satellite information transmission system 503 according to the present embodiment.

FIG. 33 illustrates a state in which the satellite information transmission system 503 is viewed from above the equator.

Example 5 of the satellite information transmission system 503 is composed of the first communication constellation 831, a second communication constellation 832a, and ground equipment.

The first communication constellation 831 flies in an equatorial orbit. Further, in the first communication constellation 831, a plurality of satellites, which include first communication devices communicating with front and rear satellites in the traveling direction on the same orbital plane, form an annular communication network.

The second communication constellation 832a flies in an inclined orbit. Further, in the second communication constellation 832a, a plurality of satellites, which include first communication devices communicating with front and rear satellites in the traveling direction on the same orbital plane, form an annular communication network.

Each satellite of the first communication constellation 831 and the second communication constellation 832a includes the second communication device with which the first communication constellation 831 and the second communication constellation 832a communicate.

Each satellite of the first communication constellation 831 and the second communication constellation 832a transmits satellite information to ground equipment via the first communication constellation 831 and the second communication constellation 832a.

According to example 5 of the satellite information transmission system 503, there is an advantageous effect that satellite information acquired by a satellite in an equatorial orbit can be transmitted to ground equipment located in the middle latitude zone. The time zone in which the second communication constellation 832a flies over the ground equipment is known in advance from planned orbit information. Thus, there is an advantageous effect that satellite information can be transmitted to ground equipment at desired time zone when the second communication constellation 832a is composed of a plurality of orbital planes whose normal vectors are different from each other.

As described in Embodiment 1, satellites are controlled in accordance with commands transmitted from ground equipment. Ground equipment includes a satellite constellation forming unit, which forms a satellite constellation, at its processor so as to communicate with each satellite, thus forming a satellite constellation. Further, a satellite constellation forming unit is also provided to satellites. The satellite constellation forming unit of each satellite of a plurality of satellites and the satellite constellation forming unit provided to the ground equipment work together to realize the control of satellite constellations. Here, the satellite constellation forming unit of a satellite is provided, for example, to a satellite control device.

Embodiments 1 to 6 have described above each unit of each system and each device, such as a satellite watching system, a satellite information transmission system, ground equipment, a communication satellite, a monitoring system, a constituent satellite, a communication satellite constellation, a satellite constellation, an artificial satellite, and a satellite, as an independent functional block. However, the configuration of each system and each device does not have to be the configuration of the above-described embodiments. Any configuration may be employed for the functional block of each system and each device as long as the function of the above-described embodiments can be realized with the configuration. Further, each system and each device may be a single device or a system composed of a plurality of devices.

In addition, a plurality of parts or examples in Embodiments 1 to 6 may be combined and carried out. Alternatively, a single part or a single example in these embodiments may be carried out. In addition, these embodiments may be carried out by combining the whole or part of the embodiments in any way.

That is, in Embodiments 1 to 6, the embodiments can be freely combined, components of each embodiment can be arbitrarily transformed, or components in each embodiment can be arbitrarily omitted.

It should be noted that the embodiments described above are essentially preferred examples and are not intended to limit the scope of the present disclosure, the scope of the application of the present disclosure, and the scope of the uses of the present disclosure. The above-described embodiments can be variously modified as needed.

### REFERENCE SIGNS LIST

30: satellite; 310, 112, 202: satellite control device; 33, 122, 114, 204: propulsion device; 34, 115, 205: attitude control device; 35, 123, 116, 206: power supply device; 111, 201: observation device; 32, 121, 113, 203: communication device; 124, 117: camera; 41: first communication device; 42: second communication device; 43: third communication device; 44: communication satellite group; 401: communication satellite; 402: data relay satellite; 403: weather satellite; 404: observation satellite; 405: first observation and monitoring satellite; 406: positioning satellite; 407: second observation and monitoring satellite; 408: space station; 409: lunar and planetary exploration satellite; 410: exploration satellite; 411: transport aircraft; 421: optical watching satellite; 422: infrared watching satellite; 423: radio watching satellite; 424: service satellite; 425: debris removal satellite; 51: critical infrastructure; 510: infrastructure satellite group; 511: infrastructure satellite; 52: watching satellite group; 521, 521a, 521b, 521c: watching satellite; 53: watching center; 54: ground equipment per infrastructure; 530: user satellite group; 531: user satellite; 542: radio communication terminal; 544: optical communication terminal; 590: watching information; 61: first satellite; 62: second satellite; 63: third satellite; 644: fourth satellite; 64: transmission/reception switching device; 65: two-way communication terminal; 601: first satellite group; 602: second satellite group; 603: third satellite group; 500: satellite watching system; 501, 503: satellite information transmission system; 502: monitoring system; 701, 702: ground equipment; 710: watching management unit; 720: storage unit; 80: artificial satellite; 81: information processing device; 801: communication satellite constellation; 802: satellite constellation; 810: first satellite constellation; 811, 812: constituent satellite; 820: second satellite constellation; 831, 831a: first communication constellation; 832, 832a: second communication constellation; 833: third communication constellation; 910: processor; 921: memory; 922: auxiliary storage device; 930: input interface; 940: output interface; 941: display device; 950: communication device

1. A satellite watching system comprising:
a critical infrastructure to be a social infrastructure in outer space and to include an infrastructure satellite group, the infrastructure satellite group including infrastructure satellites flying in an earth orbit (LEO: Low Earth Orbit) with an orbital altitude between 500 km and 2000 km inclusive;
a watching satellite group to include a watching satellite, the watching satellite flying in an orbit with an orbital altitude of 2000 km or lower to monitor the infrastructure satellite group and provide an on-orbit service;
ground equipment to be located on a ground and to exchange information with each of the infrastructure satellites of the infrastructure satellite group; and
a watching center to be located on the ground and to exchange information with the watching satellite, wherein
the infrastructure satellite group includes a communication satellite group to include a communication satellite,
the communication satellite group flies in an orbit with an orbital altitude and an orbital inclination angle which are features of a sun-synchronous orbit, the communication satellite group orbiting an integer number of times per day in a uniform arrangement,
the communication satellite communicates with communication satellites flying in front and behind,
the communication satellite group includes
a first satellite to communicate with the ground equipment,
a second satellite to communicate with the watching satellite, and
a third satellite to perform only communication with communication satellites flying in front and behind, and
the watching satellite and the watching center exchange information via the communication satellite group.

2. The satellite watching system according to claim 1, wherein
each communication satellite of the communication satellite group flies in an orbit that is a sun-synchronous orbit with an orbital altitude of 1666 km and orbits 12 times per day, and
the communication satellite group includes five or more communication satellites.

3. The satellite watching system according to claim 1, wherein
each communication satellite of the communication satellite group flies in an orbit that is a sun-synchronous orbit with an orbital altitude of 1248 km and orbits 13 times per day, and
the communication satellite group includes six or more communication satellites.

4. The satellite watching system according to claim 1, wherein
each communication satellite of the communication satellite group flies in an orbit that is a sun-synchronous orbit with an orbital altitude of 881 km and orbits 14 times per day, and
the communication satellite group includes seven or more communication satellites.

5. The satellite watching system according to claim 1, wherein
the communication satellite group includes a satellite group that is in a sun-synchronous orbit and in two orbital planes at LST (Local Sun Time) 9:00 and LST15:00.

6. The satellite watching system according to claim 1, wherein
the communication satellite and the watching satellite include a two-way communication terminal, the two-way communication terminal including a transmission/reception switching device to realize reception and transmission by switching a receiving function and a transmitting function,
the watching center operates the transmission/reception switching device, based on a data amount α of a command, the command being transmitted to the watching satellite, and a data amount β of watching report data, the watching report data being received from the watching satellite, so that a ratio between reception operating time, in which the receiving function of the two-way communication terminal works, and transmission operating time, in which the transmitting function of the two-way communication terminal works, becomes α versus β, and
the watching satellite and the watching center exchange information via the communication satellite.

7.-12. (canceled)

13. Ground equipment that is used in the satellite watching system according to claim 1, wherein
the ground equipment is located at a latitude of 60° or greater and communicates with the first satellite every orbit.

14. A communication satellite that is used in the satellite watching system according to claim 1, the communication satellite comprising:
a first communication device to communicate with the ground equipment; and
three second communication devices to allow communication between the infrastructure satellites, wherein
the communication satellite simultaneously communicates with a communication satellite flying in a same orbital plane and a watching satellite or a user satellite.

15. A communication satellite that is used in the satellite watching system according to claim 1, the communication satellite comprising:
a first communication device to communicate with the ground equipment;
a second communication device to allow communication between the infrastructure satellites; and
a third communication device to communicate with a watching satellite or a user satellite.

16. A monitoring system comprising:
a first satellite constellation to monitor the Earth, a flying object, and a space object by satellite groups including three or more satellites working together;
ground equipment to exchange information with a satellite constituting the first satellite constellation; and
a second satellite constellation to relay satellite information by communication satellite groups, the communication satellite groups including six or more communication satellites that fly in a sun-synchronous orbit with an orbital altitude of 800 km or higher in a uniform arrangement and communicate with satellites flying in front and behind in a same orbital plane, working together, wherein
a satellite constituting the first satellite constellation exchanges information with the ground equipment via the second satellite constellation.

17. The monitoring system according to claim 16, wherein
the first satellite constellation orbits a plurality of times per day in an inclined circular orbit with an orbital altitude between 1000 km and 6000 km inclusive,
in a plurality of orbital planes that are formed by a plurality of satellites included in the first satellite constellation, normal lines are shifted from each other by equal angles in an azimuth direction and flying positions of each orbital plane are synchronously controlled.

18. The monitoring system according to claim 16, wherein
the first satellite constellation flies in a sun-synchronous non-frozen elliptical orbit with perigee altitude of 300 km or more and apogee altitude of 6000 km or less, and
in a plurality of orbital planes that are formed by a plurality of satellites included in the first satellite constellation, azimuth direction components of respective major diameters are shifted from each other by equal angles.

19. The monitoring system according to claim 16, wherein
the first satellite constellation orbits a plurality of times per day in an equatorial orbit, where azimuth direction components are shifted from each other by equal angles and flight positions are synchronously controlled.

20. The monitoring system according to claim 16, wherein
the second satellite constellation includes
a first satellite to communicate with the ground equipment,
a second satellite to communicate with a satellite constituting the first satellite constellation, and
a third satellite to perform only communication with satellites flying in front and behind.

21. The monitoring system according to claim 16, wherein
the second satellite constellation relays the satellite information in a manner such that communication satellite groups, the communication satellite groups includes six or more communication satellites flying in a sun-synchronous orbit and in each orbital plane at LST (Local Sun Time) 09:00 and LST15:00, work together.

22. The monitoring system according to claim 16, wherein
the ground equipment is a movable body.

23. A constituent satellite that constitutes the first satellite constellation used for the monitoring system according to claim 17.

24. A constituent satellite that constitutes the second satellite constellation used for the monitoring system according to claim 16.

25. Ground equipment that is used for the monitoring system according to claim 16.

26.-34. (canceled)

35. An artificial satellite comprising:
at least one of a computing machine or a super computer, the computing machine or the super computer having AI (Artificial Intelligence), and a cloud server or an edge server, as an information processing device, wherein
the artificial satellite flies in a sun-synchronous orbit at LST (Local Sun Time) 06:00 or LST18:00, and
a solar cell is oriented to a sunlight incident side and a heat dissipation surface of the information processing device is provided on an opposite side of sunlight incidence.

36. A communication satellite constellation that flies in a sun-synchronous orbit at LST (Local Sun Time) 06:00 or LST18:00, the communication satellite constellation comprising:
a communication satellite including a communication device for communicating with a ground, wherein
a communication device that allows communication between communication satellites flying in front and behind in a same orbital plane is provided to form an annular communication network.

37. A satellite constellation that flies in a sun-synchronous orbit at LST (Local Sun Time) 06:00 or LST18:00, the satellite constellation comprising:
a satellite including at least one of a computing machine or a super computer, the computing machine or the super computer having AI (Artificial Intelligence), and a cloud server or an edge server, as an information processing device, in which a solar cell is oriented to a sunlight incident side and a heat dissipation surface of the information processing device is provided on an opposite side of sunlight incidence; and
a satellite including a communication device to communicate with a ground, wherein
a communication device that allows communication between satellites flying in front and behind in a same orbital plane is provided to form an annular communication network.

38. A satellite information transmission system comprising:
a user satellite group to include a user satellite flying in LEO (Low Earth Orbit) being an earth orbit with an orbital altitude between 500 km and 2000 km inclusive;
a communication satellite group to include a plurality of communication satellites flying in a sun-synchronous orbit at LST06:00 or LST18:00; and
ground equipment, wherein
each communication satellite in the communication satellite group communicates with communication satellites flying in front and behind, and
the communication satellite group includes a first satellite to communicate with the ground equipment and a second satellite to communicate with the user satellite, and
the user satellite and the ground equipment exchange information via the communication satellite group.

39. A satellite information transmission system comprising:
a first communication constellation that flies in an equatorial orbit and in which a plurality of satellites, the plurality of satellites including a first communication device to communicate with front and rear satellites in a traveling direction on a same orbital plane, form an annular communication network;
a second communication constellation that flies in a sun-synchronous orbit and in which a plurality of satellites, the plurality of satellites including a first communication device to communicate with front and rear satellites in a traveling direction on a same orbital plane, form an annular communication network; and
ground equipment, wherein
each satellite of the first communication constellation and the second communication constellation includes a second communication device with which the first communication constellation and the second communication constellation communicate and transmits satellite information to the ground equipment via the first communication constellation and the second communication constellation.

40. A satellite information transmission system comprising:
a first communication constellation that flies in an equatorial orbit and in which a plurality of satellites, the plurality of satellites including a first communication device to communicate with front and rear satellites in a traveling direction on a same orbital plane, form an annular communication network;
a second communication constellation that flies in a sun-synchronous orbit and in which a plurality of satellites, the plurality of satellites including a first communication device to communicate with front and rear satellites in a traveling direction on a same orbital plane, form an annular communication network;
a third communication constellation that flies in an inclined orbit and in which a plurality of satellites, the plurality of satellites including a first communication device to communicate with front and rear satellites in a traveling direction on a same orbital plane, form an annular communication network; and
ground equipment, wherein
each satellite of the first communication constellation, the second communication constellation, and the third communication constellation includes a second communication device, with which the first communication constellation and the second communication constellation communicate, or the second communication constellation and the third communication constellation communicate, or the third communication constellation and the first communication constellation communicate, and transmits satellite information to the ground equipment via at least two of the first communication constellation, the second communication constellation, and the third communication constellation.

41. A satellite information transmission system comprising:
a first communication constellation that flies in a sun-synchronous orbit and in which a plurality of satellites, the plurality of satellites including a first communication device to communicate with front and rear satellites in a traveling direction on a same orbital plane, form an annular communication network;
a second communication constellation that flies in a sun-synchronous orbit at different LST (Local Sun Time) from that of the first communication constellation and in which a plurality of satellites, the plurality of satellites including a first communication device to communicate with front and rear satellites in a traveling direction on a same orbital plane, form an annular communication network; and
ground equipment, wherein
each satellite of the first communication constellation and the second communication constellation
includes a second communication device with which the first communication constellation and the second communication constellation communicate when passing near a polar region, and
transmits satellite information to the ground equipment via the first communication constellation and the second communication constellation.

42. A satellite information transmission system comprising:
a first communication constellation that flies in an equatorial orbit and in which a plurality of satellites, the plurality of satellites including a first communication device to communicate with front and rear satellites in a traveling direction on a same orbital plane, form an annular communication network;
a second communication constellation that flies in an inclined orbit and in which a plurality of satellites, the plurality of satellites including a first communication device to communicate with front and rear satellites in a traveling direction on a same orbital plane, form an annular communication network; and
ground equipment, wherein
each satellite of the first communication constellation and the second communication constellation includes a second communication device with which the first communication constellation and the second communication constellation communicate and transmits satellite information to the ground equipment via the first communication constellation and the second communication constellation.

43. Ground equipment that is used in the satellite information transmission system according to claim 38.

44. A satellite that constitutes the communication satellite constellation according to claim 36.
